(19) United States
(12) Patent Application Publication
(10) Pub. No.: US 2026/0230292 A1
(43) Pub. Date: Aug. 6, 2026

(54) METHODS FOR UE SIMULTANEOUS TRANSMISSION AND RECEPTION

(71) Applicant: InterDigital Patent Holdings, Inc., Wilmington, DE (US)

(72) Inventors: Tao Deng, New York, NY (US); Jonghyun Park, Syosset, NY (US); Nazli Khan Beigi, Longueuil (CA); Virgil Comsa, Montreal (CA); Moon IL Lee, Melville, NY (US); Paul Marinier, Brossard (CA); Aata EI Hamss, Laval (CA); Virgile Garcia, Antibes (FR)

(73) Assignee: InterDigital Patent Holdings, Inc., Wilmington, DE (US)

(21) Appl. No.: 19/044,216

(22) Filed: Feb. 3, 2025

(51) Int. Cl. H04L 5/14; H04B 17/345; H04L 5/00; H04W 24/10; H04W 72/1273; H04W 72/54

(52) U.S. Cl. CPC H04L 5/14; H04B 17/345; H04L 5/0055; H04L 5/0073; H04W 72/1273; H04W 72/54; H04W 24/10

(57) ABSTRACT

Methods are disclosed for a wireless transmit receive unit (WRTU)-side full duplex (FD) transmission and reception to determine and report hypothetic/candidate UL self-interference based on a DL channel measurement with simultaneous UL transmission and a set of (pre)configured UL transmission hypotheses. In one example, methods are disclosed for WTRU measurement and reporting self-interference cancellation (SIC) ratio(s) and/or SIC ratio offset(s) corresponding to a default/reference configuration and a configuration of hypothetical candidate UL reference signal parameters for simultaneous UL transmission. In one example, methods are disclosed for WTRU measurement of actual channel state information (CSI) of DL RS with simultaneous UL transmission and determination of hypothetical/candidate CSI based on the actual CSI and SIC ratio offset corresponding to the difference in TX parameters between the actual and hypothetical simultaneous UL transmissions, e.g. a different transmission control indicator (TCI) state. Additional embodiments are disclosed.

### BACKGROUND

The main duplexing schemes supported in Fifth Generation (5G) new radio (NR) efforts are frequency division duplex (FDD) and time division duplex (TDD). In FDD, different carriers are designated for uplink (UL) and downlink (DL) transmissions, i.e. user equipment (UE) transmission and reception are separated in the frequency domain. Simultaneous transmission and reception can thus be performed in different carriers but requires paired DL and UL spectrum allocation. In TDD, one carrier is used for both UL and DL transmission, i.e. UE transmission and reception are separated in the time domain. Thus, a UE cannot perform simultaneous transmission and reception and instead switches between UL transmission and DL reception in the time domain.

To improve network capacity, especially for UL performance and reducing data transmission latency, a new full duplex (FD) scheme has been introduced based on non-overlapping UL and DL sub-band for simultaneous transmission and reception, respectively. It is referred as gNB-side Sub-Band Full Duplex (SBFD) and enables a gNB to simultaneously transmit and receive in different frequency sub-bands within a TDD carrier. It is however not supported for the UE due to implementation complexity, and thus a UE applies TDD in the same carrier.

In the Third Generation Partnership Program (3GPP) R18 gNB-side SBFD framework, a TDD carrier is partitioned into DL and UL frequency sub-bands separated with a guard band, i.e. non-overlapping UL and DL sub-bands. The DL/UL sub-band configuration is indicated semi-statically to UEs, e.g., in radio resource control (RRC) signaling and system information block one (SIB1) transmission. Additionally, SBFD symbols can be configured and a gNB can transmit and receive in the configured DL sub-band and UL sub-band over the same SBFD symbols.

Full duplex schemes also includes SBFD with overlapping UL and DL sub-bands and furthermore in-band full duplex (IBFD) using the same UL and DL sub-band, i.e. fully overlapping UL and DL frequency allocation, is being studied. As SBFD technology continues evolving, UE-side FD capability is expected to be a next step for implementation in certain types of 6G UEs, e.g., fixed wireless access (FWA) UEs or Vehicular UEs.

As mentioned, in 5G and 5G advanced (5GA), the UE does not transmit and receive simultaneously. As a result, the design of baseline functions and procedures, e.g., scheduling and power control, does not take into consideration the need to address UE self-interference for UE-side FD, i.e. the interference from a UE's transmission to its own reception during simultaneous UL transmission and DL reception. A large guard band between UL and DL sub-bands can minimize self-interference, but it is not efficient in spectrum utilization. It is beneficial to consider a framework based on UE SBFD with a small guard band and/or UE IBFD. Thus, it is desired to design new mechanisms (e.g., for scheduling and power control) to efficiently handle the self-interference resulting from the simultaneous transmission and reception by the UE. How to enable simultaneous UE transmission and reception with efficient self-interference handling is an issue that should be addressed.

### SUMMARY

One or more of the foregoing issues may be address in a first aspect of the disclosure for UE, also referred to herein as wireless transmit receive unit (WRTU), determination and reporting of hypothetic/candidate self-interference of DL channel information based on a DL channel measurement with simultaneous UL transmission and a set of (pre)configured UL transmission hypotheses.

In one example, methods are disclosed for WTRU measurement and reporting of one or more self-interference cancellation (SIC) ratio and/or SIC ratio offsets corresponding to a default/reference and hypothetical/candidate simultaneous transmission (Tx) and reception (Rx) configuration.

In another example, methods are disclosed for WTRU measurement of actual channel state information (CSI) of a simultaneous UL transmission and reception and determination of hypothetical/candidate CSI based on the actual CSI and SIC ratio offset corresponding to the difference Tx parameter between the actual and hypothetical simultaneous UL transmission configuration including, e.g. a TCI state.

A specific method for a WTRU may include receiving downlink (DL) channel measurement configuration information including: (i) a RX configuration of a DL reference signal (RS) in a receive (RX) sub-band and a first TX configuration of an associated actual simultaneous uplink (UL) RS in a transmit (TX) sub-band; and (ii) a second TX configuration of a candidate simultaneous uplink (UL) RS in the transmit (TX) sub-band. The WTRU measures the received DL RS associated with the simultaneous UL RS transmission according to the RX configuration and the first TX configuration, respectively. The WTRU may determine an actual CSI based on the measured DL RS for the first RX and TX configuration and determines a self-interference cancellation (SIC) value based on for the second TX configuration relative to the first TX configuration. The WTRU may report, to a gNB, the determined actual CSI, the first TX configuration and the determined SIC value corresponding to the second TX configuration.

In one example, the SIC value is a SIC ratio or a SIC offset corresponding to the difference of one or more parameter(s) between the first TX configuration and the second TX configuration. In another example aspect, reporting the determined SIC value includes reporting a hypothetical CSI for the candidate simultaneous UL RS for future simultaneous UL transmission using the second TX configuration. In one example, the hypothetical CSI is based on the actual CSI and the determined SIC value. In another example, only the hypothetical CSI which exceed a configured CSI threshold are reported.

In various examples, the DL RS may be one of a control resource set (CORESET), a synchronization signal block (SSB), a physical downlink control channel (PDCCH) demodulation reference signal (DMRS) or a scheduled physical downlink shared channel (PDSCH) DMRS. The associated simultaneous UL RS may be one of a sounding reference signal (SRS), a physical uplink control channel (PUCCH), a physical uplink shared channel (PUSCH) or a dedicated UL RS. The second TX configuration includes an assumption of one or more transmission parameters for a candidate simultaneous UL transmission including a transmit power level, an UL transmission TCI state, a TX and RX polarization, a TX and RX spatial filter and/or a DL and UL frequency resource allocation. The SIC value may be a SIC ratio offset for a candidate UL RS for future simultaneous UL transmission based on calibrated SIC ratio data of the WTRU specific to the one or more transmission parameters.

In another aspect, a WTRU may determine and report a maximum power of a UL transmission based on an indicated quality target of an associated simultaneous DL reception and a corresponding DL channel measurement.

In one example, methods are disclosed for WTRU determination of a maximum simultaneous transmit power of an UL transmission associated with a DL reception and its associated quality target and reporting of the result to gNB, e.g. in a power headroom report (PHR) or other type of reports before, or after, applying the determined power.

In a further aspect, a WTRU may determine a WTRU-side sub-band full duplex (SBFD) maximum UL transmit power based an indicated quality target of a simultaneous DL reception quality target and a corresponding DL channel measurement and further prioritization between the UL transmission and DL reception.

In one example, methods are disclosed for a WTRU to perform when the determined maximum simultaneous transmit power exceeds the power calculated based on the UL transmission grant including prioritization between UL transmission and DL reception, and performing simultaneous UL transmission with the maximum simultaneous power. Additional aspects, features and/or advantages will become apparent from the detailed embodiments described hereafter.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a power spectral density verses frequency diagram showing an example of simultaneous uplink (UL) transmission (Tx) and downlink (DL) reception (Rx) with a first configuration and a first resulting self-interference cancellation (SIC) ratio;

FIG. 2B is a power spectral density verses frequency diagram showing an example of simultaneous UL Tx and DL Rx with a second configuration and second resulting SIC ratio, and showing a difference in SIC ratio and/or DL measurement result difference of X decibels (dB) between the first and second configuration as a result of a SIC ratio offset due to different TX beams;

FIG. 3 is a power spectral density verses frequency diagram showing examples of simultaneous UL maximum transmit power in relation to the associated DL reception and non-simultaneous UL transmit powers;

FIG. 4 is a flow diagram showing an example method for WTRU determination and reporting of hypothetic/candidate self-interference DL channel information based on a DL channel measurement with simultaneous UL transmission and a set of (pre)configured UL transmission hypothesis according to an embodiment;

FIG. 5 is a flow diagram showing an example method for WTRU determination and reporting of maximum power of a UL transmission based on an indicated quality target of an associated simultaneous DL reception and a corresponding DL channel measurement according to an embodiment; and

FIG. 6 is a flow diagram showing an example method for WTRU determination of WTRU-side sub-band full duplex (SBFD) maximum UL transmit power based an indicated quality target of a simultaneous DL reception quality target and a corresponding DL channel measurement and further prioritization between the UL transmission and DL reception according to an embodiment.

### DETAILED DESCRIPTION

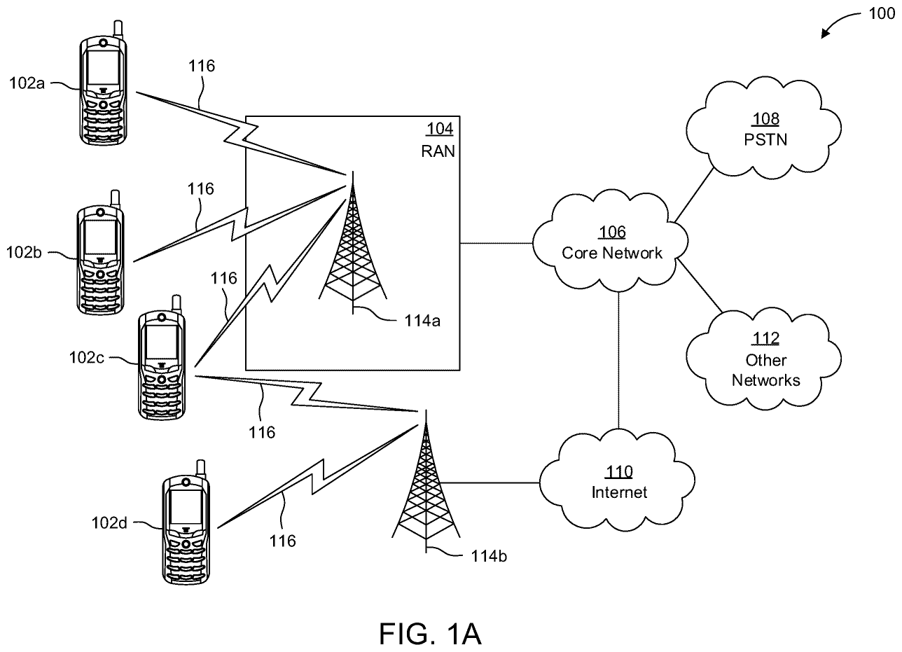

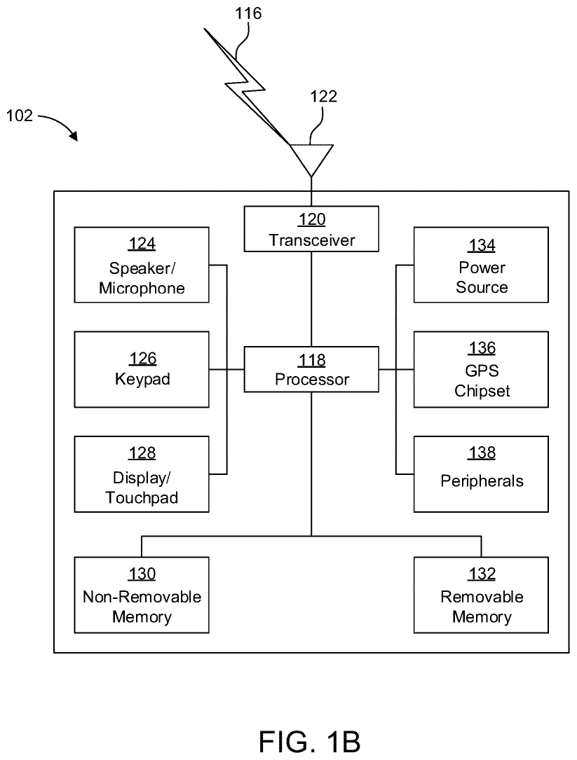

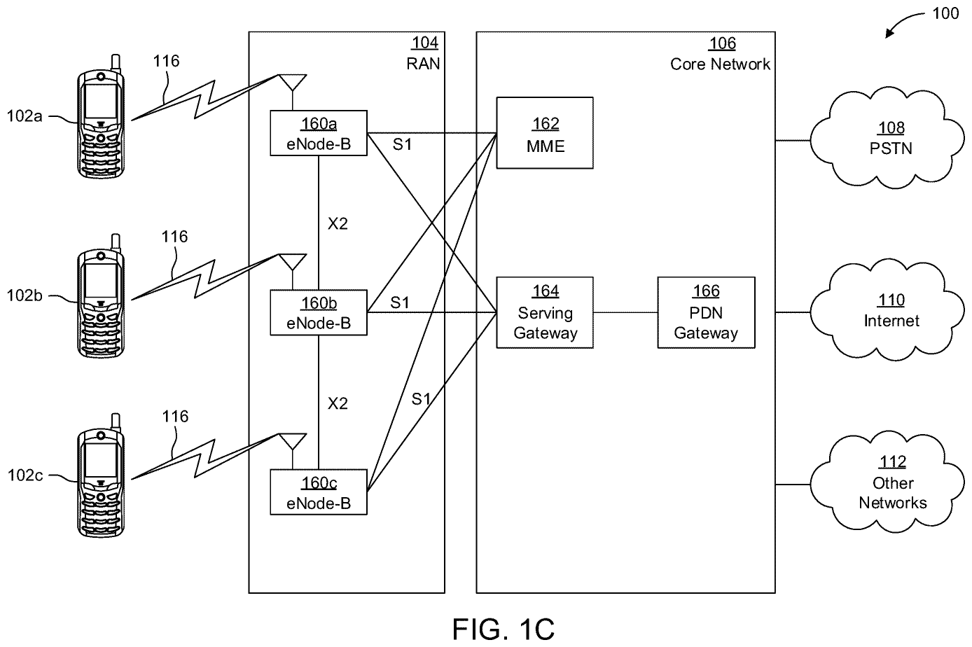

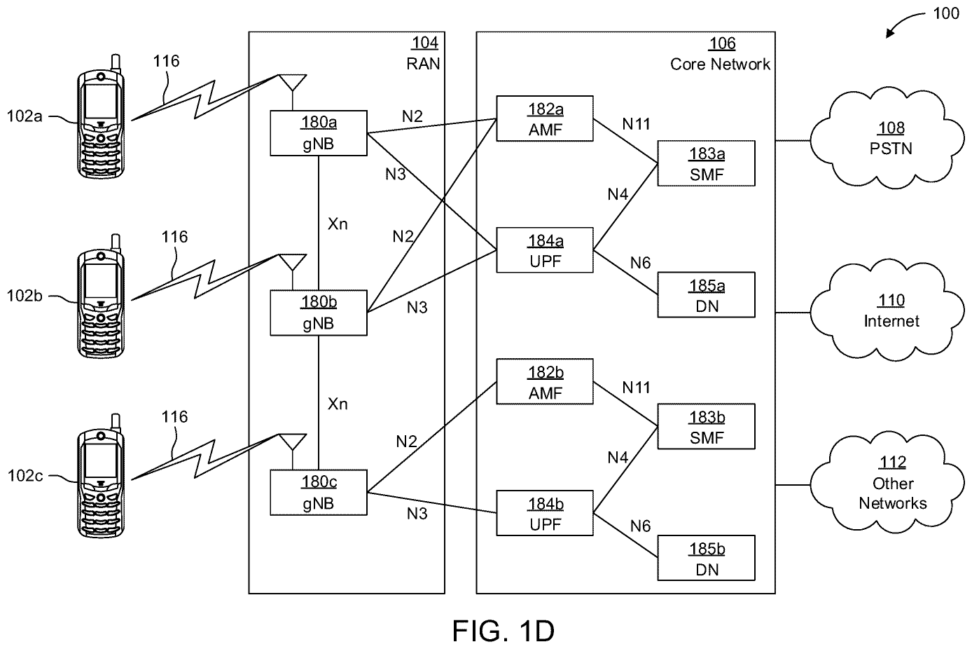

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Details of full duplex (FD) transmissions are now described. A duplexing scheme describes how transmission and reception by a same entity may be separated. As mentioned previously, the main duplexing schemes supported in 5G NR are frequency division duplex (FDD) and time division duplex (TDD). In FDD, different carriers are designated for UL and DL transmissions, i.e. WTRU transmission and reception is separated in the frequency domain. Simultaneous transmission and reception can thus be performed in different carriers but requires paired DL and UL spectrum allocation. In TDD, one carrier is used for both UL and DL transmission, i.e. WTRU transmission and reception are separated in the time domain. Thus, a WTRU cannot perform simultaneous transmission and reception and instead switches between UL transmission and DL reception in the time domain.

To improve network capacity, especially for UL performance and reducing data transmission latency, a new full duplex (FD) scheme was introduced in 5GA NR R18 for the gNB and based on non-overlapping UL and DL sub-band for simultaneous transmission and reception, respectively. It is referred as gNB-side sub-band full duplex (SBFD). This technique enables a gNB to simultaneously transmit and receive in different frequency sub-bands within a TDD carrier. It is however not supported thus far for the UE/WTRU due to implementation complexity, and thus a WTRU applies TDD in the same carrier as previous releases.

In the R18 gNB-side SBFD framework, a TDD carrier is partitioned into DL and UL sub-bands separated with a guard band, i.e. non-overlapping UL and DL sub-bands. The DL/UL sub-band configuration is indicated semi-statically to WTRUs, e.g., in RRC signaling and SIB1 transmission. Additionally, SBFD symbols can be configured and a gNB can transmit and receive in the configured DL sub-band and UL sub-band over same SBFD symbols, i.e., simultaneously.

Full duplex schemes also includes SBFD with overlapping UL and DL sub-band and furthermore in-band full duplex (IBFD) using same UL and DL sub-band, i.e. fully overlapping UL and DL frequency allocation.

As SBFD technology continues evolving, WTRU-side FD capability is expected to be the next step for implementation in certain types of 6G WTRUs, e.g., fixed wireless access (FWA) WTRU or Vehicular WTRU. The main motivations are e.g., low WTRU transmit power compared to gNB transmission will lead to lower self-interference and thus more relaxed requirement in implementation. Also, those types of WTRUs can have large form factor and more advanced hardware (e.g. equipped with separated TX and RX antenna panels, large circulators, analogue sub-band filtering) and software processing (e.g. enabling more sophisticated digital SIC algorithms), which can facilitate FD capability.

With FD capability, e.g., SBFD or IBFD, a WTRU can perform UL transmission of critical control information (e.g. hybrid automatic repeat request (HARQ)) or data while continuing to receive a large amount of DL data transmitted in consecutive slots. This WTRU-side simultaneous WTRU transmission and reception is beneficial in several 6G use cases, e.g., extended reality (XR) scenarios where DL and UL data has stringent roundtrip time (RTT) constraints. Overall, WTRU-side FD operation can provide further latency reduction and UL coverage improvement in addition to gNB-side FD operation. WTRU simultaneous transmission and reception enabled by WTRU-side FD capability is thus considered as a candidate for 6G study in R20 and beyond.

As mentioned previously, in currently 5G and 5GA operation, a WTRU does not transmit and receive simultaneously. As a result, the design of baseline functions and procedures, e.g., scheduling and power control, does not take into consideration the need to address UE/WTRU self-interference, i.e. the interference resulting from a WTRU's transmission and own reception during simultaneous UL transmission and DL reception. A large guard band between UL and DL sub-bands can reduce WTRU self-interference, but it is not efficient in spectrum utilization. It is beneficial to consider a framework based on WTRU-side SBFD with a small guard band and/or WTRU IBFD. Thus, solutions and new mechanisms (e.g., for scheduling and power control) to efficiently handle the self-interference caused by the simultaneous transmission and reception are needed.

Details for general full duplex operation and configuration are now described. In various embodiments, a WTRU may receive configurations (e.g., from a gNB, a node, or a device) for full-duplex (FD) operation conducted by at least one device in a network. A WTRU may operate in an FD mode for communicating with the gNB. A WTRU may report a corresponding WTRU capability to a gNB and receive a response/confirmation from the gNB, e.g., to configure, indicate and/or enable the FD mode to use for the WTRU in accordance with the reported WTRU FD capability. In various examples, the aforementioned reporting and response/confirmation may be transmitted in layer 1(L1) control signaling, medium access control (MAC) control element (CE) and/or RRC signaling by a WTRU and gNB, respectively or some combination of these methods.

In a FD operation a network entity (e.g., a WTRU or gNB) may transmit a first signal (a transmitted signal (TX)) and simultaneously receive a second signal (a received signal (RX)). In various examples, a WTRU transmitted signal/UL signal may, be a physical uplink control channel (PUCCH), a physical uplink shared channel (PUSCH), a sounding reference signal (SRS), an UL positioning reference signal (UL PRS) transmission, a dedicated FD UL signal and/or other similar types of transmissions. In various examples, a WTRU received signal/DL signal may, for example, be a physical downlink control channel (PDCCH), physical downlink shared channel (PDSCH), channel state information reference signal (CSI-RS), synchronization signal block (SSB), DL PRS, a phase tracking reference signal (PTRS) reception a dedicated FD DL signal and/or other similar types of DL receptions. Additionally, the transmitted and received signals may be any of the sidelink (SL) signals and/or channels, e.g., PSCCH, PSSCH, SL CSI-RS, SL SSB and/or SL PRS.

In various implementations, a network entity (e.g., a WTRU or gNB) may be (pre)configured/indicated with a frequency domain resource allocation for the transmission of the first signal and reception of the second signal, e.g., a full duplex sub-band configuration. The frequency domain resources may be denoted as a sub-band and include e.g., one or more sub-carriers, resource elements (REs), resource blocks (RBs), resource element groups (REGs) and/or control channel elements (CCEs). In one solution, a network entity (e.g., a WTRU or gNB) may be (pre)configured/indicated with partially or fully overlapping frequency domain resources for the transmission of the first signal and reception of the second signal. For example, a WTRU may be (pre)configured and/or indicated with an in-band FD (IBFD) configuration with a partially or fully overlapping UL and DL sub-band. In another solution, a network entity (e.g., a WTRU or gNB) may be (pre)configured/indicated with non-overlapping frequency domain resources for the transmission of the first signal and simultaneous reception of the second signal. For example, a WTRU may be (pre)configured and/or indicated with a sub-band FD (SBFD) configuration with non-overlapping UL and DL sub-bands and a guard band in-between.

Hereafter, for the brevity of discussion, the FD operation may comprise the SBFD operation for simultaneous UL transmission and DL reception. The solutions and examples in this disclosure may be equally (equivalently or extendedly) be applicable to and/or be employed for any FD operation including, e.g., SBFD and IBFD. Also, the solutions and examples in this disclosure may be equally (equivalently or extendedly) be applicable to and/or be employed for any types of simultaneous WTRU/gNB transmission and reception including e.g., WTRU/gNB performing simultaneous UL transmission and DL reception and/or the WTRU performing simultaneous SL transmission and SL reception.

In addition, for the brevity of discussion, a transmit configuration indication (TCI) may be used in this disclosure to describe a spatial direction where the energy of a transmission or a reception may be concentrated. This may be equivalent to and exchangeable with the terms including, e.g., beam (TX beam for transmission and RX beam for reception), spatial filter configuration used for TX and RX and/or spatial transmit and receive parameters.

Quasi co-location (QCL) assumptions and configurations are described. A WTRU may receive transmit configuration indication (TCI) related configuration(s), e.g., comprising a plurality of TCI-states (e.g., an RRC-configured pool of TCI-states (e.g., as unified TCI framework), ‘TCI-State’ information element (IE), ‘TCI-UL-State’ IE, ‘spatialRelationInfo’ IE, etc.). A TCI-state of the plurality of TCI-states may be associated (comprised) with at least one of QCL-info #1, QCL-info #2, additionalPCI, pathloss RS(PLRS)-ID, uplink power control (UL-PC), timing advance group (TAG)-ID, where QCL-info #1 (or QCL-info #2) may include a cell-ID (e.g., serving-cell index), a bandwidth part (BWP)-ID, a RS (e.g., CSI-RS, SSB-index), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop(CL)-index, power offset, etc.) may be for determining an uplink power for an UL transmission associated with the TCI-state. In an example, the additional physical cell identity (PCI) may be a physical cell-ID (PCID) of a neighboring (surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on received timing advance command (TAC)(s) in association with the TAG-ID (e.g., of multiple TAG-IDs being configured) to a scheduled UL transmission.
typeA may represent {Doppler shift, Doppler spread, average delay, delay spread},
typeB may represent {Doppler shift, Doppler spread},
typeC may represent {Doppler shift, average delay}, and
typeD may represent {Spatial Rx parameter}.

When a WTRU receives an indication or configuration of a TCI-state (e.g., applicable for a physical channel or signal) at least having a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, Spatial Rx parameter) based on the indicated QCL-type, and apply the at least one parameter for transmission or reception of the physical channel or signal.

Embodiments may utilize a unified TCI (UTCI). A unified TCI (e.g., a common TCI, a common beam, a common RS, etc.) may refer to a beam/RS to be (simultaneously) used for multiple physical channels/signals. The term “TCI” may at least have a TCI state that includes at least one source RS to provide a reference (e.g., WTRU assumption) for determining QCL and/or spatial filter.

In an example, a WTRU may receive (e.g., from a gNB) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all (or subset of) CORESETs in a component carrier (CC). In an example, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant/configured-grant based PUSCH and all (or subset of) dedicated PUCCH resources in a CC.

The WTRU may be configured with a first mode for unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station(BS), a gNB, a transmission and reception point (TRP), etc.) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode, a parameter of ‘unifiedTCI-StateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a CORESET Pool identity (e.g., CORESETPoolIndex, a TRP indicator, and/or the like).

Hereafter, unified TCI may be interchangeably used with one or more of unified TCI-states, unified TCI instance, TCI, and TCI-state, but still consistent with the disclosed embodiments.

In various embodiments, a WTRU may be configured with a plurality of transmission configuration indicator (TCI) states, e.g., unified TCI (UTCI) states, each applicable for multiple channel(s)/signal(s). The multiple channel(s)/signal(s) may be configured to the WTRU (or pre-determined or defined), e.g., in a form of a list, by a higher-layer signaling (e.g., RRC and/or MAC-CE) which may include at least one of following (e.g., as a combination):
One or more CORESETs
One or more PDCCH candidates
One or more search spaces
One or more PDSCHs (e.g., PDSCH occasions/configurations/instances, etc.)
One or more RSs (e.g., CSI-RSs, DMRSs, SSB indexes, PRSs, PTRSs, and/or SRSs)
One or more PUSCHs (e.g., PUSCH occasions/configurations/instances, etc.)
One or more PUCCH resources (e.g., PUCCH resource sets/groups)
One or more PRACH occasions/resources/RSs

The plurality of TCI states may be configured via an RRC signaling (e.g., and/or via a MAC-CE signaling, indication or activation). The WTRU may receive, e.g., via the MAC-CE or a separate signaling, an information content comprising mapping between one or more codepoints of a downlink control information (DCI) field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

Example embodiments for WTRU self-interference cancellation (SIC) determination and reporting are disclosed. Details of SIC and SIC ratio are disclosed. In one solution, a WTRU may perform simultaneous transmission and reception in (pre)configured/indicated respective frequency and/or time domain resource allocation. A frequency domain resource allocation may be a (pre)configured/indicated physical resource block (PRB) allocation, sub-band and/or carrier. In one example, a WTRU may be (pre)configured and/or indicated with one or more SBFD-related configuration(s) including e.g. frequency domain resource allocation information of one or more sub-bands (e.g., DL sub-band, UL sub-band, flexible DL sub-band, UL sub-band and/or guard band). A DL/UL sub-band configuration may include frequency domain resource allocation for non-overlapping DL sub-band and UL sub-band with a guard band in-between, e.g. a sub-band FD (SBFD) configuration. In another example, a DL/UL sub-band configuration may include partially overlapping DL and UL frequency domain resource allocation. In a further example, a WTRU may be (pre)configured/indicated with fully overlapping DL and UL frequency domain resource allocation, i.e. an in-band full duplex (IBFD) configuration.

In certain examples, the SBFD-related configuration may include, e.g., time domain resource allocation information associated with one or more of the (pre)configured/indicated sub-band(s). The time domain resource allocation information may indicate a set of symbol(s), e.g., SBFD symbol(s) on which a WTRU may perform SBFD operation and perform simultaneous transmission and reception in the (pre)configured/indicated UL and DL sub-bands, respectively. The time domain resource allocation information may indicate a set of symbol(s), e.g., non-SBFD symbol(s) on which a WTRU may not perform SBFD operation and may not perform simultaneous transmission and reception. In one example, a WTRU may be (pre)configured and/or indicated that a DL, UL or flexible symbol may be a SBFD symbol. In another example, a WTRU may be (pre)configured and/or indicated that a DL, UL or flexible symbol may be a non-SBFD symbol. In a further example, a WTRU may be indicated that a DL, UL or flexible symbol may be a SBFD symbol or non-SBFD symbol in a DCI and/or MAC CE signaling.

A simultaneous transmission by a WTRU may leak into the WTRU's receiver and cause interference in the WTRU's own reception. This interference may be referred to as self-interference (SI) in simultaneous WTRU transmission and reception. According to various embodiments, a WTRU may implement self-interference cancellation (SIC) mechanisms in hardware and/or software to, e.g., reduce or remove the energy of a UL transmission that may interfere with a simultaneous DL reception. Examples of SIC mechanisms may include, e.g., RF circulator, analogue sub-band filtering and/or digital SIC algorithms. Theses SIC mechanisms may not fully remove the transmission that may leak into the WTRU's own reception. In one example, the interference with a DL reception caused by the remaining UL transmission may be referred to as residual self-interference (RSI).

In certain embodiments, a WTRU may determine, measure, indicate and/or report a WTRU capability of self-interference cancellation (SIC) using, e.g., a self-interference cancellation (SIC) value. In one example, a WTRU may determine, measure, indicate and/or report a SIC value as a SIC ratio representing a difference (e.g., in unit of dB) between the transmit power level of UL transmission and the residual self-interference power level received in a DL reception after SIC. A WTRU may indicate and/or report a reference/default SIC ratio corresponding to a (pre)configured reference/default set of TX and RX parameters. In one example, in WTRU capability reporting, a WTRU may indicate/or report a minimum SIC ratio corresponding to a (pre)defined reference/default set of TX and RX parameters.

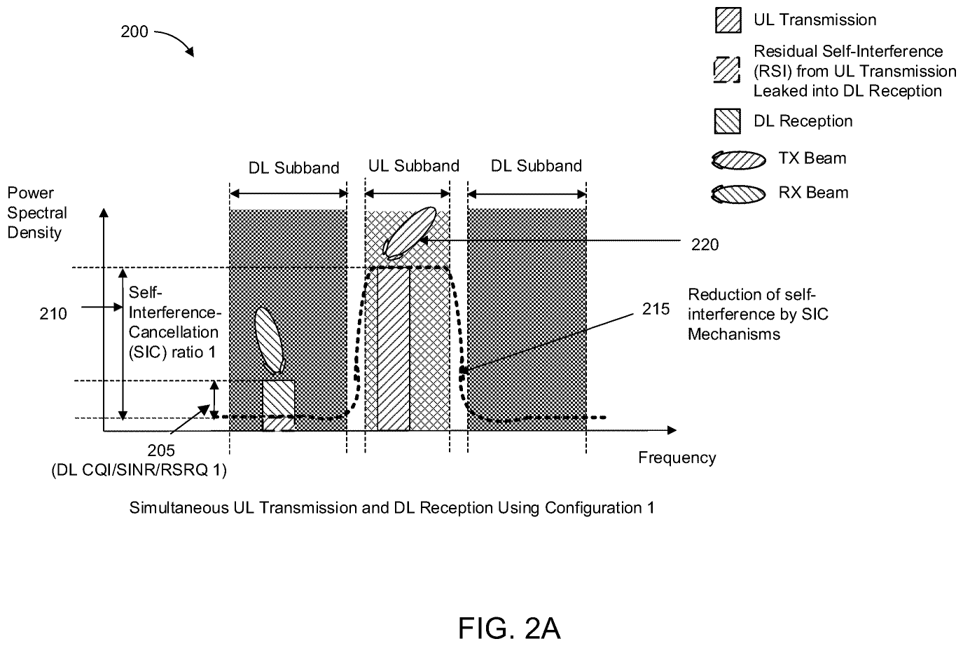

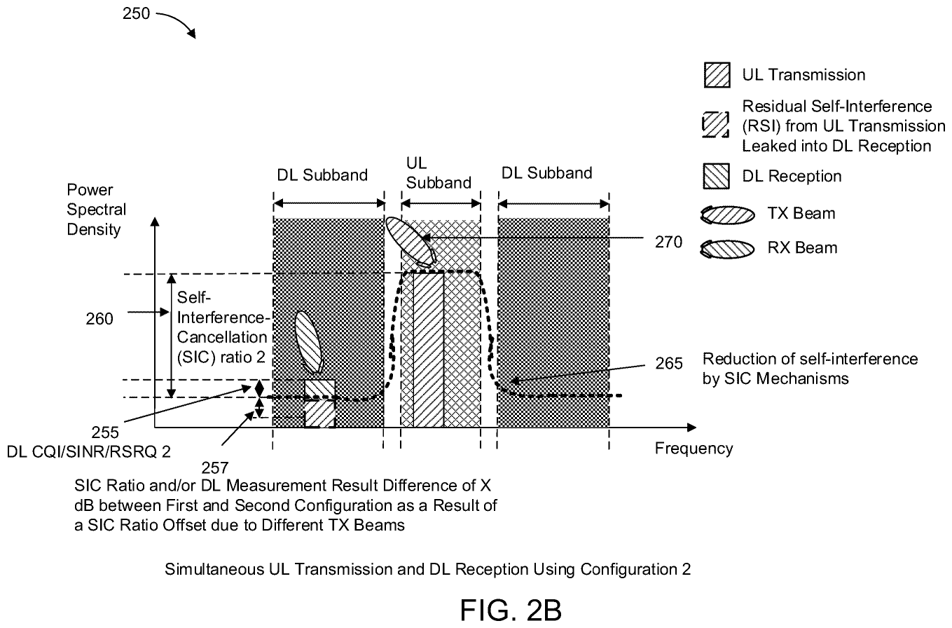

In another solution, a WTRU may be (pre)configured with, measure, determine, maintain and/or store a set of SIC ratio and/or SIC ratio offsets where each SIC ratio and/or SIC ratio offset may correspond to one or more transmission and reception parameters. In one example, a WTRU may be (pre)configured with, measure, determine, maintain and/or store with SIC ratio offset specific to one or more following TX and RX parameters (1)-(6) used for a simultaneous UL transmission and DL reception.
(1) TX and RX antenna panel physical separation. A WTRU may be equipped with TX and RX antenna panels with a physical separation to block transmission between TX and RX antennas, which may be e.g., a distance between TX and RX antenna panels and/or a physical separator. This may account for a SIC and/or a SIC offset due to the signal attenuation by the physical separation. A WTRU may be (pre)configured, determine, maintain and/or store a SIC ratio and/or SIC offset corresponding to each combination of equipped TX and RX antenna panels. In one example, a WTRU may be (pre)configured, determine, maintain and/or store a SIC ratio offset in terms of dBs between each pair of TX and RX antenna panels.
(2) TX and RX antenna polarization. A WTRU may be equipped with TX and RX antennas with vertical, horizontal or cross polarization. A WTRU may be (pre)configured, determine, maintain and/or store a SIC ratio and/or a SIC ratio offset corresponding to a combination of the polarization of the TX and RX antenna used for a simultaneous UL transmission and DL reception. This may account for a SIC and/or a SIC offset due to the orthogonality of TX and RX antenna polarization. For example, a WTRU may be (pre)configured, determine, maintain and/or store a SIC ratio offset of 3 dB corresponding to TX and RX antennas using different and orthogonal polarization (e.g., TX antenna using vertical and RX antenna using horizontal polarization and vice versa). In another example, a WTRU may be (pre)configured, determine, maintain and/or store a SIC ratio offset of 0 dB corresponding to TX and RX antennas using the same polarization.
(3) TX and RX spatial filter configuration, i.e. TX beam and/or RX beam. A WTRU may be (pre)configured, determine, maintain and/or store a SIC ratio and/or SIC ratio offset corresponding to a pair of TX and RX spatial filter configurations, i.e. a pair of TX and RX beams. In one example, a WTRU may be (pre)configured, determine, maintain and/or store a SIC ratio and/or SIC ratio offset corresponding to a pair of UL and DL TCI states and/or corresponding to a unified TCI state of a simultaneous UL transmission and DL reception, respectively. This may account for the SIC ratio and/or SIC ratio offset due to spatial isolation of simultaneous UL transmission and DL reception. A WTRU may be (pre)configured, determine, maintain and/or store a SIC ratio/offset corresponding to a (pre)defined quantity (e.g., in units of angular degree) of the alignment between a pair of TX and RX spatial filter configuration. The more an UL transmission direction may align with a DL reception direction, i.e. a TX beam and RX beam may align in spatial domain, the more UL transmission energy may leak into the DL reception, which may result into a lower SIC potential. In one example, as shown in FIG. 2A diagram 200 and FIG. 2B diagram 250, a WTRU may be (pre)configured, determine, maintain and/or store a SIC ratio offset of X dB between the two indicated simultaneous UL transmission and DL reception configurations when the difference of the first configuration (e.g., FIG. 2A) and second configuration (e.g., FIG. 2B) may be the different TX beams used for the UL transmissions. A WTRU may accordingly determine a SIC of the first configuration (FIG. 2A) may be larger than the SIC of the second configuration (FIG. 2B) by X dB. As a result, a WTRU may determine a residual self-interference (RSI) of the second configuration may be higher by X dB and the corresponding channel information metric, e.g., channel quality indicator (CQI), signal interference to noise ratio (SINR), reference signal received quality (RSRQ) may be lower by X dB as shown in FIG. 2B. The value of X may be determined based on a WTRU calibration.
(4) TX and RX signal and/or channel type. A WTRU may be (pre)configured, determine, maintain and/or store a SIC ratio and/or SIC ratio offset corresponding to a combination of simultaneous UL and DL transmission signal and/or channel type. In one example, a UL transmission and DL reception may include a reference signal transmission (e.g., SRS, CSI-RS, PRS, PTRS and/or DMRS) using a Gold sequence, M sequence or Zadoff Chu (ZC) sequence. In another example, UL transmission and DL reception may include a control and/or a data channel (e.g. PUCCH, PUSCH, PDCCH and/or PDSCH). A WTRU may be (pre)configured, determine, maintain and/or store a SIC and/or SIC ratio corresponding the TX signal and/or channel type. This may account for the SIC due to the signal properties, e.g., peak to average power ratio (PAPR), modulation (quadrature phase shift keying (QPSK), quadrature amplitude modulation (QAM), etc.), channel coding (Polar coding, low density parity check (LDPC) coding, etc.). The higher PAPR of a UL transmission or DL reception signal and/or channel, the lower the SIC ratio may be. In one example, a WTRU may be (pre)configured and/or indicated with a fixed SIC offset between two different types of signal and/or channels.
(5) TX and RX frequency domain resource allocation. A WTRU may be (pre)configured, determine, maintain and/or store a SIC ratio and/or SIC ratio offset corresponding to the frequency domain resource allocation of simultaneous UL transmission and DL reception. In one example, a WTRU may be (pre)configured, determine, maintain and/or store a SIC ratio corresponding to the frequency domain resource separation between the UL transmission and DL reception frequency resource allocation. The separation may be the frequency gap, e.g., in terms of number of sub-carrier, RBs, REGs, CCEs, sub-bands between the upper edge of the DL frequency domain resource allocation and the lower edge of the UL frequency domain resource allocation. The larger the separation, the higher the SIC ratio may be. In another example, a WTRU may be (pre)configured, determine, maintain and/or store a SIC ratio and SIC ratio offset corresponding to the size of the UL transmission and/or DL reception, e.g., in unit of number of sub-carriers, PRBs, REGs and/or CCEs.
(6) The transmitter to receiver channel. In another example, a WTRU may estimate the channel experienced by the version of a transmitted signal leaked into the receiver. In one example, a WTRU may apply the channel estimate to derive the received version of a transmitted signal and cancel/reduce it using a digital SIC algorithm.

A WTRU may receive one or more abovementioned TX and RX parameters in scheduling information for the simultaneous UL transmission and DL reception, respectively. As an example, the scheduling information may be indicated in DCI for scheduling dynamic grant (DG)-and configured grant (CG)-based data channel transmission and reception. For example, a WTRU may determine the TX antenna, TX beam, TX antenna polarization, TX frequency domain resource allocation, TX signal and/or channel type based on the TX antenna port, TCI state, TX antenna panel indication, TX PRB allocation and TX signal/channel type indicated in the received scheduling information, e.g., a DCI scheduling a PUSCH transmission. Also, a WTRU may determine the RX antenna, RX beam, RX antenna polarization, RX frequency resource allocation and/or RX signal property for a PDSCH transmission based on the RX antenna panel port, the TCI state, a RX antenna panel indication, RX PRB allocation and/or RX signal/channel type indicated in the received scheduling information, e.g., a DCI scheduling a PDSCH reception. In another example, a WTRU may receive such scheduling information in a RRC configuration and/or by MAC CE indication for CG-based data channel(s), control channel(s) and/or reference signals.

A WTRU may determine the above-discussed SIC ratio and/or SIC ratio offset(s) corresponding to the different TX and/or RX parameter based on WTRU internal measurement, WTRU implementation and/or calibration of SIC mechanisms.

Example default/reference and candidate/hypothetical SIC ratio determination and reporting are now described. In one solution, a WTRU may be (pre)configured and/or indicated with the following simultaneous UL transmission and DL reception configurations (1)-(2) and report the corresponding SIC ratios and/or SCI ratio offsets.
(1) A default/reference simultaneous UL transmission and DL reception configuration with a default/reference set of TX and RX parameters. In one example, the configuration may include one or more of the abovementioned TX and RX parameters for a simultaneous SRS transmission and SSB, PDCCH and/or CSI-RS measurement reception. The UL transmission power of the default/reference configuration may be a maximum transmit power. The default/reference DL TCI state may be configured and activated for a SSB, PDCCH and/or CSI-RS reception for a primary serving cell (PCell) a WTRU may camp on and the UL TCI state may correspond to a TCI state activated and used for a SRS and/or PUCCH transmission. In one example, a default/reference configuration may indicate a zero-power DL reception configuration, i.e. a WTRU may not receive a DL signal and/or channel within the configured DL reception resource. A WTRU may perform a measurement using the configured RX parameters, e.g., RX antenna port and RX TCI state to measure the residual self-interference from the simultaneous transmission.
(2) A set of candidate/hypothetical simultaneous UL transmission and DL reception configuration(s). Each candidate/hypothetical configuration may include one or more different TX and RX parameters compared with the default/reference simultaneous UL transmission and DL reception configuration. In one example, a candidate/hypothetical configuration may use a different DL and/or UL TCI state configured and activated for DL reception (e.g., PDCCH/PDSCH/CSI-RS/SSB/TRS) and/or UL (e.g. SRS/PUCCH/PUSCH) transmission, respectively. In another example, a candidate/hypothetical configuration may apply UL transmission power level with an increase or a decrease of a (pre)configured step size compared to that applied in the default/reference configuration. In a further example, a candidate/hypothetical simultaneous UL transmission and DL reception may include a different UL transmission signal type. Additionally, a candidate/hypothetical simultaneous UL transmission and DL reception may apply a larger or smaller UL transmission frequency allocation, e.g., by a (pre)configured incremental step size, e.g., including 2 PRB, 4 PRB, 8 PRBs, etc., than the UL transmission frequency domain resource allocation of the default/reference configuration. In certain embodiments, a WTRU may be indicated with an identity of a candidate/hypothetical configuration, e.g., using an index.

In one solution, a WTRU may perform measurement in the configured default/reference DL resource with a simultaneous UL transmission according to the default/reference configuration and measure the residual self-interference (RSI) within the DL reception. A WTRU may determine a default/reference SIC ratio as the difference between UL transmission power and the measured RSI in the simultaneous DL reception.

A WTRU may determine a SIC ratio and/or SIC ratio offset corresponding to each candidate/hypothetical configuration without performing a SIC ratio measurement. A WTRU may determine a SIC ratio offset corresponding to a candidate/hypothetical configuration based on the SIC ratio offset corresponding to each different TX and/or RX parameter between the default/reference and candidate configuration. Referring to FIG. 2B, when a candidate/hypothetical configuration (configuration 2) and FIG. 2A default/reference configuration (configuration 1) may use a different TX beam, a WTRU may determine the SIC ratio of the candidate/hypothetical configuration may be smaller than that of the default/reference configuration by a SIC ratio offset X dB, i.e. a SIC ratio offset corresponding to the different TX beams. Accordingly, a WTRU may determine the SIC ratio of the candidate/hypothetical configuration may be the default/reference SCI ratio minus X dB.

In another example, a WTRU may determine a SIC ratio offset corresponding to the different UL transmission power levels of default/reference and candidate/hypothetical configuration. The SIC ratio offset may be proportional to and/or equal to the difference in power level offset in units of dB. In one example, when the transmit power levels of the two configurations may differ by Y dB, the SIC ratio offset of the candidate/hypothetical configuration may be Y dB.

A WTRU may determine a SIC ratio of a candidate/hypothetical configuration by applying one or more SIC ratio offset(s) corresponding to different TX and/or RX parameters to the measured default/reference SIC ratio, e.g., by adding/subtracting the applicable SIC offset(s) to/from the measured SIC ratio. In the examples shown in FIGS. 2A and 2B, when the candidate/hypothetical configuration 250 may apply a different TX beam and a TX power which may be Y dB higher than the default/reference configuration 200, a WTRU may determine the SIC ratio offset corresponding to the candidate/hypothetical configuration 250 may be the sum of the SIC ratio offsets for TX beam and power level difference, i.e. X+Y dB. Accordingly, a WTRU may determine the SIC ratio of the candidate/hypothetical configuration 250 may be the default/reference SCI ratio minus (X+Y) dB.

Similarly, a WTRU may determine an SIC ratio offset corresponding to the different polarization of UL transmission antenna in the default/reference and candidate configuration and apply to the SIC ratio determination of the candidate/hypothetical configuration as discussed above. In this example, a WTRU may apply a (pre)configured fixed offset in unit of dBs corresponding to different TX and RX antenna polarization combination.

A WTRU may be (pre)configured and/or indicated to report the SIC values, e.g., ratios corresponding to the default/reference and candidate/hypothetical configurations, in a SIC ratio reporting transmitted in PUCCH, MAC CE and/or RRC signaling. In one example, a WTRU may report the measured default/reference SIC ratio and SIC ratio(s) and/or SIC offset(s) corresponding to configured candidate configuration(s), i.e. candidate/hypothetical SIC ratio(s) and/or SIC offset(s).

In another example, a WTRU may determine to report the measured default/reference SIC ratio and a sub-set of candidate/hypothetical SIC ratio(s) and/or SIC ratio offset(s) based on the values of the candidate/hypothetical SIC ratio(s) and SIC ratio offset(s) and (pre)configured rules. A WTRU may be (pre)configured and indicated with one more of following related rules:
A WTRU may determine to report candidate/hypothetical SIC ratio(s) and/or SIC ratio offset(s) and corresponding configurations when the candidate/hypothetical SIC ratio(s) may be larger or smaller than the measured default/reference SIC ratio by a (pre)configured threshold.
A WTRU may determine to include a (pre)configured number of highest and/or lowest candidate/hypothetical SIC ratio(s) and/or SIC ratio offset(s) and corresponding configuration(s).

In certain embodiments, a WTRU may autonomously determine to report a sub-set of candidate/hypothetical SIC ratio(s) and/or SIC ratio offset(s) corresponding to one or more candidate/hypothetical simultaneous UL transmission and DL reception configuration(s) that may not be configured and/or indicated by the gNB. In one example, a WTRU may first determine candidate/hypothetical SIC ratio(s) and/or SIC ratio offset(s) corresponding to candidate/hypothetical configurations for all possible combinations of the above-discussed TX and RX parameters. For example, when a WTRU may be equipped with 2 RX antennas and 2 TX antennas (each with fixed polarization and separation) and configured/indicated with 8 RX TCI states, 16 TX TCI states, the WTRU may determine 2×2×8×16=512 candidate/hypothetical configurations and corresponding SCI ratio(s) and/or SIC ratio offset(s). A WTRU may determine to report a (pre)configured number of highest and/or lowest SIC ratio(s) and/or SIC offset(s) and associated simultaneous UL transmission and DL reception configurations.

Embodiments may include WTRU self-interference DL channel measurement and reporting. In one solution, a WTRU may indicate the impact of self-interference on a DL reception using channel state information of a DL channel interfered by self-interference of the simultaneous UL transmission and report the information to the network for scheduling purposes. A WTRU may determine, be (pre)configured to and/or be indicated to perform channel state information measurement of a self-interference DL channel, i.e. a self-interference DL CSI measurement and report the measurement results to the network. A self-interference DL channel may be defined as a DL channel for a DL signal and/or channel reception, which may be interfered by a simultaneous UL signal and/or channel transmission performed by the same WTRU.

Self-interference DL channel measurement configuration examples are disclosed. A WTRU may receive a self-interference DL channel measurement configuration including one or a combination of the following items (1)-(3):
(1) DL channel measurement configuration. Example DL channel configuration information may include one or more of the following items (A)-(D):
   (A) DL channel measurement type. A WTRU may be (pre)configured with a DL CSI measurement to perform, e.g., reference signal received power (RSRP), reference signal received quality (RSRQ), SINR, reference signal strength indicator (RSSI), CQI, Precoder Matrix Index (PMI), Rank Indicator (RI), Time Domain Channel Property (TDCP), Interference Measurement (IM), etc.
   (B) Indication of the measurement purpose. A WTRU may be (pre)configured with a measurement purpose in the DL CSI measurement configuration. In one example, a WTRU may be (pre)configured or indicated with a self-interference DL CSI measurement configuration, e.g., for the purpose of beam management, DL CSI measurement, interference measurement, radio resource management (RRM) measurement, etc.
   (C) DL channel measurement signal. A WTRU may be (pre)configured with a DL reference signal and/or channel on which to perform a DL measurement. The DL reference signal and/or channel may be a CSI-RS, SSB, PDCCH DMRS, PDSCH DMRS, PTRS, PDCCH and/or PDSCH. A WTRU may be indicated with an identity of the sequence used for the DL measurement signal, e.g., a sequence index and/or a cyclic shift index of the sequence. In another example, a WTRU may be (pre)configured and/or indicated to perform interference measurement (IM) in time domain resource allocated for a UL transmission without DL measurement signal transmission.
   (D) DL channel measurement resource and associated RX parameters for the DL reception and measurement. A WTRU may be (pre)configured with one or more of the following RX parameters associated with the DL measurement reference signal resource:
Frequency domain parameters, e.g. the allocated sub-carrier(s), RB(s), RE(s), Resource Element Group (REG), Control Channel Element (CCE)s;
Time domain parameters, e.g., starting symbol positioning, number of symbols, periodicity, sub-frame number, system frame number (SFN), periodicity, repetition factor. In one example for IM measurement without DL measurement signal transmission, a WTRU may be (pre)configured and/or indicated to perform the DL channel measurement in the time domain resource allocated for an associated simultaneous UL transmission, e.g., within symbols scheduled for SRS, PUCCH, PUSCH and/or other UL signal/channel transmissions; and/or
Spatial domain parameters, e.g., RX antenna port(s), TCI state associated with this DL measurement resource (i.e. the RX Beam used for the measurement).

In another solution, the associated simultaneous UL transmission configuration may include the RX parameters indicated in the default/reference simultaneous UL transmission and DL reception configuration, as discussed previously for SIC ratio reporting.
(2) Associated simultaneous UL transmission configuration. A WTRU may perform an actual UL transmission according to the configuration in same DL channel measurement time domain resource, i.e. a simultaneous UL transmission. The UL transmission configuration may include one or more of the following items (A)-(C).
   (A) UL transmission signals. A WTRU may be (pre)configured with a UL RS transmission (e.g. SRS), a PUCCH and/or a PUSCH transmission. In another example, a WTRU may be (pre)configured with a self-interference measurement reference signal.
   (B) UL transmission resource and associated TX parameters for the UL transmission. A WTRU may be (pre)configured with one or more of the following TX parameters associated with the simultaneous UL transmission (i)-(vi):
      (i) Frequency domain parameters, e.g. the allocated sub-carrier(s), RB(s), RE(s), comb pattern and RE offset and/or frequency hopping configuration;
      (ii) Time domain parameters, e.g., starting symbol positioning, number of symbols, periodicity, sub-frame number, SFN, periodicity, repetition factor. The time domain parameters may be identical to the aforementioned DL channel measurement time domain resource parameters;
      (iii) Spatial domain parameter, e.g., TX antenna port(s), TCI state, Spatial relationship;
      (iv) Transport format, e.g., MCS and transport block size for PUSCH transmission;
      (v) Sequence type and length, e.g., a ZC sequence for SRS transmission; and/or
(vi) Power domain parameters, e.g., UL power control parameter(s) such as nominal power value (P0), power compensation ratio (alpha), pathloss reference signal (PL RS), closed-loop PC adjustment index (CL-index), etc.
   (C) A WTRU may determine a transmit power level based on the power control applicable to the configured UL transmission signal. In another example, a WTRU may apply a (pre)configured reference transmit power level.

In another solution, the associated simultaneous UL transmission configuration may include the TX parameters indicated in the default/reference simultaneous UL transmission and DL reception configuration discussed previously for SIC ratio reporting.
(3) One or more hypothetical/candidate UL transmission configuration(s). Each hypothetical/candidate UL transmission configuration may include one or more different TX parameter(s) compared with the corresponding parameter(s) in the associated simultaneous UL transmission configuration. The different parameter may include, e.g. a different UL TCI state, a different transmit power level, a different UL frequency domain resource allocation. In another solution, the associated simultaneous UL transmission configuration may include the TX parameters indicated in the hypothetical/candidate simultaneous UL transmission and DL reception configuration discussed previously for SIC ratio reporting.

Actual DL CSI measurement and hypothetical/candidate CSI determination examples are now described. A WTRU may be (pre)configured and/or indicated to perform a self-interference DL channel CSI measurement and determine corresponding hypothetical/candidate CSI information. The configuration and/or indication may be included in one or a combination of DCI, MAC CE and/or RRC signaling.

A WTRU may perform a DL channel CSI measurement according to the DL channel measurement configuration on a configured DL channel measurement signal. For example, a WTRU may perform a CQI/SINR/RSRQ measurement in a configured downlink CSI-RS resource. In another example, a WTRU may perform a PDCCH CQI/SINR/RSRQ measurement in a configured downlink PDCCH DMRS resource over one or more CORESET symbol(s). The CORESET may be configured to be associated with a common and/or UE/WTRU-specific search space (CSS and/or USS). In a further example, a WTRU may perform a SSB CQI/SINR/RSRQ measurement in a configured SSB resource over one or more SSB symbol(s). In another example, a WTRU may perform a RSSI/interference measurement (IM)/Noise measurement according to the DL channel measurement configuration without a DL channel measurement signal. While performing the abovementioned DL channel CSI measurement, a WTRU may perform a UL transmission according to the associated simultaneous UL transmission configuration.

In one solution, a WTRU may determine an actual CSI based on the performed DL channel CSI measurement with the actual UL transmission. A WTRU may subsequently determine one or more hypothetical/candidate CSI(s) each of which may correspond to hypothetical/candidate UL transmission configuration. A hypothetical/candidate CSI may be considered as a CSI that a WTRU may have measured using the same DL channel measurement configuration but with a hypothetical/potential candidate UL transmission, e.g., a CSI modeling of the DL channel measurements based on hypothetical information of various potential changes in a simultaneous UL transmission parameters.

A WTRU may determine a hypothetical/candidate CSI based on the actual measured CSI and a SIC ratio offset corresponding to the hypothetical/candidate UL transmission configuration. A WTRU may determine the SIC ratio offset based on SIC ratio offset(s) corresponding to each different TX parameter of the actual UL transmission and hypothetical/candidate transmission configurations.

In an example solution, a WTRU may determine the SIC ratio/offset as discussed previously with respect to FIGS. 2A and 2B between a default/reference UL transmission and one or more hypothetical/candidate UL transmission configurations. A WTRU may determine a SIC ratio/offset corresponding to a candidate/hypothetical UL transmission configuration based on the SIC ratio offset corresponding to each different TX parameter between the actual and hypothetical/candidate UL transmission configurations. In an example, a WTRU may determine the difference between hypothetical/candidate CSI and the actual measured CSI may be proportional to and/or equal to the difference in SIC ratio offset of the hypothetical/candidate UL transmission configuration relative to the actual simultaneous UL transmission configuration.

As shown in FIG. 2B, when a candidate/hypothetical transmission configuration (configuration 2) and actual transmission configuration (configuration 1 of FIG. 2A) may use a different TX beam, a WTRU may determine the SIC ratio offset corresponding to a candidate/hypothetical UL transmission configuration may be X dB, i.e. the SIC ratio may be smaller than the actual transmission configuration by X dB. A WTRU may determine the hypothetical/candidate CSI, e.g. CQI/SINR/RSRQ may be the actual measured CQI/SINR/RSRQ value minus X. In another example, when the CSI measurement may be RSSI/IM/Noise measurement, a WTRU may determine the hypothetical/candidate CSI may be the actual measured CQI/SINR/RSRQ value plus X.

In another example, a WTRU may determine a SIC ratio offset corresponding to the different UL transmission power levels of actual UL transmission and candidate/hypothetical transmission configurations. As discussed previously, the SIC ratio offset may be proportional to and/or equal to the difference in power level offset in unit of dB. When the transmit power level of hypothetical/candidate UL transmission configuration may be Y dB higher than the actual transmission configuration, a WTRU may determine the hypothetical/candidate CQI/SINR/RSRQ may be the actual measured CQI/SINR/RSRQ value minus Y. Additionally, or alternatively, a WTRU may determine the hypothetical/candidate RSSI/IM/Noise measurement may be the actual measured RSSI/IM/Noise measurement plus Y.

As previously discussed, a WTRU may determine a SIC ratio of a candidate/hypothetical configuration by applying one or more SIC ratio offset(s) corresponding to all different TX parameter(s) to the actual measured CSI. In the same examples shown in FIGS. 2A and 2B, when the candidate/hypothetical configurations may apply a different TX beam and a TX transmit power which may be Y dB higher than the actual UL transmission configuration, a WTRU may determine the SIC ratio offset corresponding to the candidate/hypothetical configuration may be the sum of the SIC ratio offsets for TX beam and power level difference, e.g., X+Y dB. Accordingly, a WTRU may determine the hypothetical/candidate CQI/SINR/RSRQ may be the actual CQI/SINR/RSRQ minus (X+Y) and the hypothetical/candidate RSSI/IM/Noise measurement may be the actual RSSI/IM/Noise measurement plus (X+Y).

A WTRU may be (pre)configured and/or indicated to report actual measured and hypothetical/candidate CSI, e.g., CQI/SINR/RSRQ/RSSI/IM/Noise measurement in PUCCH, MAC CE and/or RRC signaling. In one example, a WTRU may report the actual measured CSI and the hypothetical/candidate CSI corresponding to all hypothetical/candidate UL configuration(s).

In another example, a WTRU may determine to report the actual measured CSI and a sub-set of candidate/hypothetical CSI based on the values of the candidate/hypothetical CSI and (pre)configured rules. By way of example, a WTRU may be (pre)configured and indicated with one more of following related rules:
A WTRU may determine to report candidate/hypothetical SCI and corresponding configurations when the candidate/hypothetical CSI may be larger or smaller than the actual measured CSI by a (pre)configured threshold; and/or
A WTRU may determine to include a (pre)configured number of highest and/or lowest candidate/hypothetical CSI(s) and corresponding configuration(s).

In a further solution, a WTRU may autonomously determine to report a sub-set of candidate/hypothetical CSI corresponding to one or more candidate/hypothetical simultaneous UL transmission configuration(s) that may not be configured and/or indicated by the gNB. In one example, a WTRU may first determine candidate/hypothetical CSI corresponding to candidate/hypothetical configurations for all possible combinations of TX and RX parameters as previously discussed for SIC ratio and/or SIC ratio offset reporting. A WTRU may determine to report a (pre)configured number of highest and/or lowest CSI and associated simultaneous UL transmission and DL reception configuration.

FD-symbol-type-specific DL CSI measurement and reporting is now discussed. In certain embodiments, a WTRU may receive configurations for more than one symbol-type (e.g., slot-type, subframe-type, time-unit related type), where the more than one symbol-type may include, e.g., a non-FD symbol type and a FD (e.g., SBFD and/or IBFD) symbol type. The WTRU may receive a time-domain configuration (e.g., applicable symbol indexes) for each of the non-FD symbol type and the FD symbol type, separately. The WTRU may be configured or indicated to perform the WTRU self-interference DL channel measurement and reporting, when (e.g., only when) the corresponding measurement occasion overlap with the FD symbol type. The WTRU may maintain one or more UL Tx parameter sets (e.g., dedicatedly, separately) used in symbols of the FD symbol type, where each set of the one or more UL Tx parameter sets may include at least one of the abovementioned associated TX parameters for the UL transmission.

In one example, a first set of the one or more UL Tx parameter sets may include a first UL-TCI state and/or a first UL PC parameter set having at least one of {P0, alpha, PL RS, CL-index}, and a second set of the one or more UL Tx parameter sets may include a second UL-TCI state and/or a second UL PC parameter set having at least one of {P0, alpha, PL RS, CL-index}. The WTRU may receive an indication (e.g., via DCI and/or MAC-CE) to apply a set (e.g., the first set or the second set) of the one or more UL Tx parameter sets for the FD symbol type (e.g., for actual UL transmissions) and/or for the WTRU self-interference DL channel measurement and reporting. The WTRU may receive an indication (e.g., via DCI and/or MAC-CE) to switch from one set (e.g., the first set) to another set (e.g., the second set).

In an example, on condition that the WTRU currently maintain the first set of the one or more UL Tx parameter sets, the WTRU may perform the WTRU Self-interference DL channel measurement and reporting by using (e.g., applying, assuming) the first set, where the WTRU may determine a hypothetical/candidate CSI based on the actual measured CSI and a SIC ratio offset based on (e.g., applying, using, assuming) the first UL-TCI state and/or the first UL PC parameter set. The WTRU may receive an indication (e.g., via DCI and/or MAC-CE) to switch from the first set to the second set. In response to the indication, the WTRU may perform the WTRU Self-interference DL channel measurement and reporting by using (e.g., applying, assuming) the second set, where the WTRU may determine a hypothetical/candidate CSI based on the actual measured CSI and a SIC ratio offset based on (e.g., applying, using, assuming) the second UL-TCI state and/or the second UL PC parameter set.

Example embodiments of WTRU maximum transmit power determination for simultaneous UL transmission and DL reception are now described.

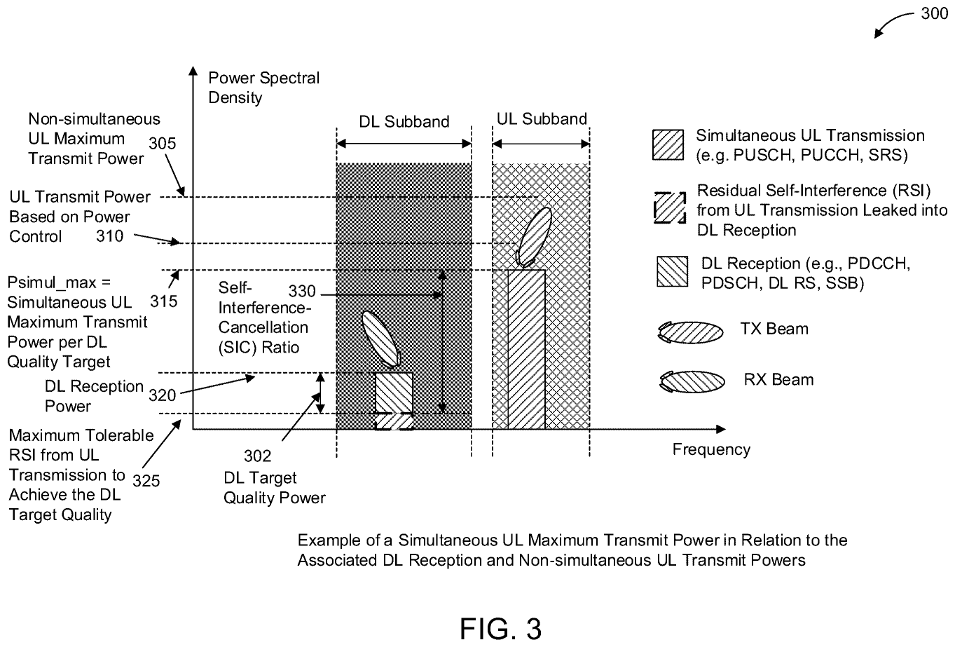

Referring to FIG. 3, a diagram 300 illustrating simultaneous UL maximum transmit power in relation to the associated DL reception and non-simultaneous UL transmit powers is shown. A WTRU may determine, be (pre)configured and/or indicated with a maximum transmit power for a UL transmission without simultaneous DL reception, i.e. non-simultaneous UL maximum transmit power (Pnon-simul_max). In addition, a WTRU may determine, be (pre)configured and/or indicated to perform a maximum power reduction (MPR), i.e. to reduce the non-simultaneous UL maximum transmit power with a (pre)configured amount of power level. A WTRU may be triggered to report a MPR-related event to the network, e.g., in a power head room (PHR) reporting. A WTRU may be (pre)configured and/or indicated with triggering conditions for MPR for non-simultaneous UL maximum transmit power and the conditions may include e.g. one or more of the following.
A WTRU may measure an electromagnetic power density of its transmission and the measurement result may exceed a (pre)configured electromagnetic power density emission exposure threshold. In one example, the threshold may be set according to compliance with regulations regarding Maximum Permissible Emission (MPE).
A WTRU may measure its transmission duty cycle and the measurement result may exceed a (pre)configured threshold.

Embodiments are disclosed for simultaneous UL maximum transmit power determination. In another solution, a WTRU may determine, be (pre)configured and/or indicated with a maximum transmit power for a UL transmission with simultaneous DL reception, i.e. simultaneous UL maximum transmit power (Psimul_max) as shown in FIG. 3. The UL transmission with simultaneous DL reception may be a scheduled/actual UL transmission or a hypothetical/candidate UL transmission using a reference configuration. A WTRU may be scheduled with UL PUSCH, PUCCH, UL RS and/or PRACH transmission and receive a corresponding UL transmission configuration in the scheduling signaling, e.g., DCI in a dynamical grant and MAC CE and/or RRC signaling. In another example, a WTRU may be configured and/or indicated with a reference configuration including, e.g., TCI state, resource allocation, signal and/or channel type, transmission power level for the hypothetical/candidate UL transmission.

The UL transmission with simultaneous DL reception may be one or more of the following transmissions (1)-(4):
(1) A PUSCH transmission. A WTRU may determine a P_{simul_max} of a dynamically and/or semi-statically scheduled PUSCH transmission. A WTRU may receive the transmission configuration including TCI state, resource allocation, MCS, etc. in the scheduling signaling (e.g., DCI for dynamical scheduling and MAC CE and/or RRS signaling for semi-static scheduling).
(2) A PUCCH transmission. A WTRU may determine a P_{simul_max} of aperiodic and/or periodical PUCCH transmission carrying e.g., CSI and HARQ information. A WTRU may receive the transmission configuration including TCI state, resource allocation, sequence type and identity, etc. in DCI for aperiodic PUCCH transmission and MAC CE and/or RRC signaling for periodic PUCCH transmission.
(3) An UL RS transmission. A WTRU may determine a P_{simul_max} of aperiodic and/or periodical UL RS transmission, e.g., SRS and UL-PRS. A WTRU may receive the transmission configuration including TCI state, resource allocation, PUCCH format, sequence type and identity, etc. in DCI for aperiodic UL RS transmission and MAC CE and/or RRC signaling for periodic UL RS transmission.
(4) A PRACH transmission. A WTRU may determine a P_{simul_max} of a PRACH transmission, e.g. WTRU-initiated PRACH in initial access and PDCCH-ordered PRACH transmission. A WTRU may receive the transmission configuration including TCI state, preamble format, resource allocation, sequence type and identity, etc. in DCI for PDCCH-ordered PRACH transmission and MAC CE and/or RRC signaling for PRACH transmissions in initial access.

In various embodiments, a WTRU may be configured and/or indicated with a DL reception scheduling in the time domain resource configured for the scheduled and hypothetical transmission. Thus, the simultaneous UL maximum transmit power may be associated with a (pre)configured/indicated DL reception and/or a target quality of the DL reception. The DL reception may include one or more of the following DL receptions (1)-(4).
(1) A PDCCH reception. A WTRU may determine a P_{simul_max} associated with a PDCCH reception within a (pre)configured and/or indicated PDCCH resource allocation, e.g., a CORESET and/or Search Space (SS).
(2) A SSB reception. A WTRU may determine a P_{simul_max} associated with a SSB reception within a (pre)configured and/or indicated SSB resource allocation, e.g. SSB symbols.
(3) A PDSCH reception. A WTRU may determine a P_{simul_max} associated with a PDSCH reception within a (pre)configured and/or indicated PDCCH resource allocation, e.g., the symbols allocated to the PDSCH reception in a dynamic grant (received in DCI) and/or configured grant (received in MAC CE and/or RRC signaling).
(4) A DL RS reception. A WTRU determine a P_{simul_max} associated with a DL RS reception within a (pre)configured and/or indicated DL RS resource allocation, e.g., the symbols allocated to the DL RS reception in a periodical configuration (received MAC CE and/or RRC signaling) and/or an aperiodic configuration (received in DCI). The DL RS may e.g. include one or more of CSI-RS, PTRS, PTRS.

A WTRU may determine the simultaneous UL maximum transmit power (P_{simul_max}) of each actual/schedule or hypothetical/candidate UL transmission associated with a DL reception based on at least the following elements (1)-(4):
(1) The associated DL reception configuration including the RX parameters previously discussed for SIC ratio and/or SIC ratio offset determination. The parameters may include at least RX antenna panel, RX antenna polarization, RX time and/or frequency domain resource allocation (e.g., SSB frequency allocation, CORESET frequency allocation, PDSCH frequency allocation), RX TCI state and/or RX signal and/or channel type.
(2) The (pre)configure and/or indicated DL reception quality target. A WTRU may be (pre)configure and/or indicated with a DL reception quality and corresponding target for the associated DL reception. In one example, the DL reception quality may be received signal level, SINR, RSRQ, CQI, RX sensitivity level, noise level, desensitization level and/or noise rise level. The corresponding target may be e.g., a threshold indicating an amount of dB for SINR, RSRQ, desensitization level and/or noise rise level. An example of SINR target may be indicated as shown by the DL target quality shown in FIG. 3. A RX sensitivity level may be a minimum received signal level in terms of dBm that may meet a block error rate (BLER) requirement of the received signal and/or channel, e.g. PDCCH and/or PDSCH. In another example, a WTRU may be configured and/or indicated with a desensitization level in terms of dB, which may indicate how much lower the signal and/or channel may be allowed to receive than the RX sensitivity level. A noise level may be the level in terms of dBm of a sum of interference and noise in the receiver. In another example, a WTRU may be configured and/or indicated with a noise rise level in terms of dB, which may indicate how much higher the noise may be allowed to rise.
(3) A set of simultaneous UL transmission configurations with each including the TX parameters previously discussed for SIC ratio and/or SIC ratio offset determination. The parameters may include at least TX antenna panel, TX antenna polarization, TX time and/or frequency domain resource allocation, TX TCI state and/or TX signal and/or channel type. As discussed above, the configurations may correspond to UL transmission scheduling information for a scheduled UL transmission or a (pre)configured reference transmission configuration for a hypothetical/candidate UL transmission. A WTRU may be (pre)configured and/or indicated with PUSCH, PUCCH and/or UL RS (e.g. RS) for each UL transmission configuration and thereby a WTRU may determine a corresponding simultaneous UL maximum transmit power for PUSCH, PUCCH and/or UL RS (e.g. SRS) and associated TX configuration.
(4) The measurement result of a corresponding DL reception without simultaneous UL transmission. A WTRU may perform a measurement e.g. received signal level, SINR, CQI, RSRQ, noise level of one or more corresponding DL reception(s) without simultaneous UL transmission. In one solution, the corresponding DL reception(s) may be within one or more DL reception occasions preceding the associated DL reception when the associated DL reception may be periodic. For example, a WTRU may measure the PDCCH, SSB and DL RS occasions preceding the associated PDCCH, SSB and DL RS reception. When the associated DL reception may be aperiodic, the corresponding DL reception(s) may be within one or more DL reception occasions closest to the associated DL reception. For example, a WTRU may measure a dynamically scheduled PDSCH when the PDSCH reception and the associated PDSCH reception may be within a (pre)configured window. The window may ensure that the measured quality may indicate accurately the quality of the associated DL reception in the future. When a WTRU may not find such corresponding DL reception within the window, a WTRU may not determine a simultaneous UL maximum transmit power for the UL transmission.

In one example, a WTRU may determine the simultaneous UL maximum transmit power (P_{simul_max}) associated with a DL reception as following (as shown by simultaneous UL maximum transmit power in FIG. 3) for each configured actual/scheduled and/or hypothetical/candidate UL transmission.

A WTRU may determine a plurality of P_{simul_max} values corresponding to different types of receptions (PDCCH, SSB, PDSCH, or any DL RS) against different WTRU antenna panels other than the one used for reception, where the panels may be associated with an SR Id. The determined P_{simul_max} values may consider antenna polarizations between Rx/Tx panel.

Additionally, if the WTRU is configured with intra-band multiple TRP operation, the determination of the plurality of P_{simul_max} values may consider spatial/WTRU panels decoupling, meaning the DL receptions and UL transmissions may take place on different beams and/or panels, and meaning the DL TCI and UL TCI may be different. A WTRU may perform a measurement, e.g., a received signal level (P_{received}), CQI, SINR, and/or RSRQ of a PDCCH, SSB, PDSCH and/or DL RS reception in a corresponding DL reception. A WTRU may determine a SIC ratio (in dB) corresponding to the TX and RX parameters included in the simultaneous UL transmission and associated DL reception, respectively, as discussed previously. For example, a WTRU may determine a SIC ratio based on the used TX and RX antenna panel and polarization, TX TCI and RX TCI state, TX and RX frequency domain resource allocation (e.g. the number of allocated RBs and the separation of TX and RX frequency domain resource). In another example, as previously discussed, a WTRU may determine a SIC ratio of the actual/scheduled UL transmission and a SIC ratio offset corresponding to the different TX parameter(s), e.g. TX TCI state between the actual/scheduled UL transmission and hypothetical/candidate UL transmission. A WTRU may further determine SIC ratio of a hypothetical/candidate UL transmission based on based on the SIC ratio of the actual/scheduled UL transmission and the corresponding SIC ratio offset.

In one example, a WTRU may determine the simultaneous UL maximum transmit power (P_{simul_max}) of an actual/scheduled or hypothetical/candidate UL transmission based on the measurement result, a (pre)configured and/or indicated DL reception quality and a corresponding target, e.g. SINR according to: P_{max_simul}=the measured signal level signal level (P_{received})+SIC ratio−CQI or SINR or RSRQ target.

In another example, a WTRU may determine the simultaneous UL maximum transmit power (P_{simul_max}) of an actual/scheduled or hypothetical/candidate UL transmission based on the measurement result, a (pre)configured and/or indicated DL reception quality and a corresponding target, e.g. SINR according to: P_{max_simul}=the measured signal level signal level (P_{received})−measured CQI or SINR or RSRQ+SIC ratio−CQI or SINR or RSRQ target.

In a further example, a WTRU may perform a measurement, e.g., a noise level without any DL reception signal (Pₙₒᵢₛₑ) (in dBm) in a corresponding DL reception. A WTRU may determine a SIC ratio (in dB) corresponding to the TX and RX parameters included in the simultaneous UL transmission and associated DL reception, respectively, as discussed above. A WTRU may determine the simultaneous UL maximum transmit power (P_{simul_max}) of an actual/schedule or hypothetical/candidate UL transmission based on the measurement result, a (pre)configure and/or indicated DL reception quality and a corresponding target, e.g. SINR according to: P_{max_simul}=the measured noise signal level (Pₙₒᵢₛₑ)+SIC ratio+allowed desensitization level and/or noise rise level

In one example, since each UL transmission configuration may have a different Tx parameter, a WTRU may associate the simultaneous maximum UL transmit power with the TX parameters.

Examples of WTRU reporting of simultaneous UL maximum transmit power are disclosed. In one example, a WTRU may transmit a reporting with a set of one or more simultaneous UL maximum transmit power(s) to the network. In various embodiments, the reporting may include one or more of the following information items (1)-(4).
(1) A set of simultaneous UL maximum transmit power values. Each value may correspond to a scheduled DL or a scheduled simultaneous UL transmission or a hypothetical/candidate UL transmission.
(2) A set of SIC ratios and/or SIC ratio offsets corresponding to the reported maximum transmit power values.
(3) One or more parameters of the associated DL configuration. In one example, a WTRU may include RX resource indication (e.g. CRI for CSI-RS, SRI for SSB, COREST index for PDCCH, time and/or frequency resource indication value for PDSCH), the RX TCI state and/or RX signal/channel type in the reporting.
(4) One or more parameters of the simultaneous UL transmission configuration. In one example, a WTRU may include TX resource indication (e.g. SRI for SRS, PUCCH resource and/or frequency resource indication value for PUSCH), TX TCI state, TX signal and/or channel type in the reporting. When the simultaneous UL transmission may be a (pre)configured and/or indicated hypothetical/candidate UL transmission, a WTRU may include a configuration identity, e.g. an index of the configuration.

In another example, a WTRU may report the above-discussed simultaneous UL maximum transmit power reporting information in a power headroom reporting. In addition, a WTRU may include one or more of the following information:
A set of power back-off event, e.g. simultaneous transmission-maximum power reduction (ST-MPR) for each simultaneous UL transmission configuration. A WTRU may include a ST-MPR in a PHR report to indicate the maximum transmit power associated with the simultaneous UL transmission and DL reception may be reduced by the indicated amount.
A set of power headroom for each simultaneous UL transmission configuration. A WTRU may compute a power headroom based on the simultaneous UL maximum transmit power (P_{simul_max}) of an actual/schedule or hypothetical/candidate UL transmission and a corresponding transmit power computed based on power control.

A WTRU may compute a required transmit power (P_{PC}) for an actual/scheduled UL simultaneous transmission based on power control. The power control may apply one or more of the following parameters of each actual/scheduled and hypothetical/candidate simultaneous UL transmission depending on one or more of:
(1) Frequency domain resource allocation, e.g. the PRBs scheduled for PUSCH received in DCI signaling and/or in MAC CE or RRC signaling, semi-statically configured PUCCH and/or UL RS frequency resource allocation;
(2) A (pre)configured reference power offset for PUSCH, PUCCH and/or UL RS (e.g. SRS);
(3) A path loss estimated by the WTRU;
(4) A MCS indicated in the PUSCH scheduling information; and/or
(5) Transport format and/or coding rate of the PUCCH and/or UL RS (e.g. SRS).

A WTRU may determine a required transmit power (P_{PC}) for a hypothetical/candidate UL simultaneous transmission based on the indicated value in the TX configuration received in MAC CE and/or RRC signaling.

A WTRU may determine a power headroom (PH) for each simultaneous UL transmission configuration by subtracting the simultaneous UL maximum transmit power (P_{simul_max}) with required transmit power (P_{PC}), i.e. PH=the simultaneous UL maximum transmit power (P_{simul_max})−required transmit power (P_{PC}).

A WTRU may be triggered to report the PHR when one or more of the following conditions may occur:
(1) The measured quality of the associated DL reception may increase or decrease by an amount larger than a (pre)configured threshold;
(2) One or more RX parameter(s) of the associated DL reception may be re-configured and/or indicated with a different value, e.g., RX TCI state, RX frequency domain resource allocation and/or RX antenna port;
(3) One or more TX parameter(s) of the simultaneous UL transmission may be re-configured and/or indicated with a different value, e.g., TX TCI state, TX frequency domain resource allocation and/or TX antenna port;
(4) The calculated simultaneous UL transmission power value may increase or decrease by an amount larger than a (pre)configured threshold;
(5) Suspension/cancellation of an associated DL reception. In another example, a WTRU may be (pre)configured and/or indicated to suspend/stop the scheduled DL reception and a WTRU may report a corresponding maximum power and/or PHR to the network;
(6) SIC ratio and/or SIC ratio offset corresponding to a TX and/or RX configuration may change, e.g. due to the HW temperature; and/or
(7) The path loss used for power control may increase or decrease by an amount larger than a (pre)configured threshold.

Example WTRU behaviors regarding applying the determined simultaneous UL maximum transmit power are described. In one example, a WTRU may receive configurations, determine, and/or be (pre)configured with time and frequency resources to transmit the report and/or indications on the determined simultaneous UL maximum transmit power. For example, the WTRU may be operating based simultaneous UL and DL transmission and reception based on a first simultaneous UL maximum transmit power. The WTRU may determine to apply a second determined simultaneous UL maximum transmit power based on one or more conditions, events, etc., as described herein. As such, the WTRU may determine, be configured and/or indicated to transmit the report before or after applying the second determined simultaneous UL maximum transmit power. One or more of the following may apply:

Indication before applying the determined simultaneous UL maximum transmit power may be provided. For example, a WTRU may determine, be (pre)configured and/or indicated to transmit the report before applying the second determined simultaneous UL maximum transmit power. For example, the WTRU may send the report including the second determined simultaneous UL maximum transmit power as soon as detecting one or more conditions and/or events. In an example, the WTRU may determine to transmit the report before applying the second determined simultaneous UL maximum transmit power. That is, the WTRU may send the report based on the first simultaneous UL maximum transmit power.

The WTRU may determine to use the first simultaneous UL maximum transmit power for report transmission based on one or more conditions. On or more of the following example conditions may apply:
Difference in UL transmit powers. In an example, the WTRU may calculate the difference between the first simultaneous UL maximum transmit power and the second determined simultaneous UL maximum transmit power. If the evaluated difference is higher than a threshold, the WTRU may determine to send the report based on the first simultaneous UL maximum transmit power and before applying the second determined simultaneous UL maximum transmit power. Otherwise, if the evaluated difference is lower than the threshold, the WTRU may determine to apply the second determined simultaneous UL maximum transmit power for the report transmission.
Time restrictions. In an example, the WTRU may determine to send the report in UL resources that coincide with a scheduled and/or configured simultaneous DL, if the time duration till the next scheduled and/or configured UL resources with no simultaneous DL is longer than a time threshold.

For example, the WTRU may not send the report in UL resources that coincide with the simultaneous UL and DL resources if the next configured and/or scheduled UL resources for sending the report, that do not coincide with simultaneous UL and DL, are closer in time than a determined, indicated, and/or configured time threshold.

Alternatively, the WTRU may send the report in UL resources that coincide with simultaneous UL and DL resources, based on the first simultaneous UL maximum transmit power, if the next configured and/or scheduled UL resources for sending the report, that do not coincide with simultaneous UL and DL, are farther in time than the corresponding time threshold.

In an example, the WTRU may send the report and/or the indication, indicating the second determined simultaneous UL maximum transmit power, based on the first simultaneous UL maximum transmit power. In another example, the WTRU may send the differential value determined based on the difference between the first and the second determined simultaneous UL maximum transmit power. In another example, the WTRU may send a flag indication, indicating that the difference between the first simultaneous UL maximum transmit power and the second determined simultaneous UL maximum transmit power may be higher than the corresponding threshold.

In an example, the WTRU may be (pre)configured, indicated, and/or determine to send the report as part of a (pre)configured CSI report. In another example, the WTRU may transmit a (special) scheduling request (SR), for example via (pre)configured PUCCH resources. As such, the WTRU may transmit the second determined simultaneous UL maximum transmit power as part of the transmitted SR. In another example, the WTRU may send the report as part of HARQ-ACK (e.g., via an enhanced codebook) transmission that may be associated with the received simultaneous DL.

Indication after applying the determined simultaneous UL maximum transmit power may be provided. For example, a WTRU that is operating based on a first simultaneous UL maximum transmit power may determine, be configured, and/or indicated to transmit the report after applying the second determined simultaneous UL maximum transmit power. The WTRU may indicate the report and/or indication on the second determined simultaneous UL maximum transmit power explicitly, where one or more of the following may apply:
Via UCI, MAC-CE, and/or RRC: For example, the WTRU may send the report as part of UCI and/or MAC-CE associated with the configured and/or scheduled UL transmission. In an example, the WTRU that is scheduled to transmit a PUCCH may include the report as part of the transmitted UCI. In another example, the WTRU that is scheduled to transmit a PUSCH may include the report as part of the transmitted MAC-CE. In an example, the WTRU may be configured to transmit the indication as part of an RRC signaling.
Via HARQ-ACK: For example, the WTRU may send the report as part of HARQ-acknowledgement (ACK) transmission that is associated with the received simultaneous DL. In an example, the WTRU may transmit an enhanced HARQ-ACK codebook, where the codebook may include a (flag) indication to indicate whether the WTRU has changed the simultaneous UL maximum transmit power. Wherein, a first value (e.g., zero) may indicate no changes in the simultaneous UL maximum transmit power is applied, where the WTRU may be using the first simultaneous UL maximum transmit power. In one example, a second flag value (e.g., one) may indicate that the second determined simultaneous UL maximum transmit power may be applied.

In an example, the WTRU may indicate the time span, during which the WTRU may apply the second determined simultaneous UL maximum transmit power. For example, the WTRU may determine the time span based on scheduled, configured, and/or indicated simultaneous UL and DL transmissions. In an example, the WTRU may indicate the starting time, the time duration, and or the end time. For example, the WTRU may indicate the time duration based on time instances, for example number of symbols, slots, frames, subframes, etc. In another example, the WTRU may indicate the time duration based on time units, for example msec, micro sec, etc.

Examples of WTRU behavior regarding simultaneous UL maximum transmit power and UL transmit power based on power control are disclosed. In a further solution, a WTRU may perform the following when the simultaneous UL maximum transmit power (P_{simul_max}) may be smaller than the required transmit power (PPC) for an actual/scheduled UL simultaneous transmission.

In certain embodiments, a WTRU may prioritize to either perform the actual/scheduled UL transmission or perform the associated DL reception. A WTRU may determine the prioritization based on one or more of the following (pre)configured rules (1)-(5).
(1) A WTRU may determine whether to transmit a scheduled PUSCH or receive a scheduled PDSCH based on the priority of the data carried in the PUSCH and PDSCH. When the PUSCH data priority may be higher, a WTRU may perform UL transmission without receiving. When the PDSCH data priority may be higher, a WTRU may perform DL reception without transmitting. A WTRU may determine to transmit PUSCH when the priorities may be the same.
(2) A WTRU may determine to transmit a PUCCH transmission including HARQ information and not receive any scheduled DL signal and/or channel simultaneously.
(3) A WTRU may determine to receive SSB and/or DL PDCCH transmission in common search space for a periodic configuration update, e.g., SI and not transmit any scheduled UL transmission.
(4) A WTRU may determine to transmit a PRACH and/or SR and not receive any scheduled DL signal and/or channel simultaneously.
(5) A WTRU may determine to transmit any TX signal and/or channel and not receive DL PDCCH in WTRU-specific search space simultaneously.

In some embodiments, a WTRU may perform simultaneously the actual/scheduled UL transmission using the simultaneous UL maximum transmit power and the associated DL reception. This may be considered as “best effort” UL transmission because the UL transmission power may be lower than the required transmit power and thus impact the UL transmission performance. In one example, a WTRU may perform the best effort simultaneous UL transmission regardless of the UL and/or DL signal/channel type and/or information content. In another example, a WTRU may perform the best effort simultaneous UL transmission when a WTRU may perform simultaneous UL RS transmission and DL RS reception. A WTRU may optionally indicate that the WTRU is applying the simultaneous UL maximum transmit power instead of the required transmit power computed based on the power control. As an example, a first codepoint value (e.g., zero) may indicate the required transmit power may be applied and a second codepoint value (e.g., one) may indicate that simultaneous UL maximum transmit power may be applied.

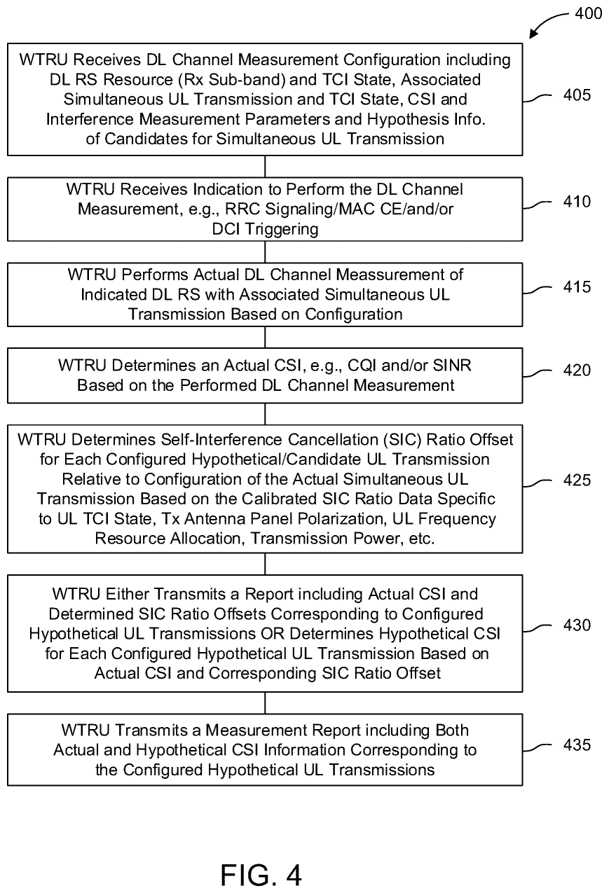

Referring to FIG. 4, a method 400 is shown for WTRU determination and reporting of hypothetic/candidate self-interference DL channel information based on a DL channel measurement with simultaneous UL transmission and a set of (pre)configured UL transmission hypothesis according to an example embodiment.

Method 400 may begin by a WTRU receiving 405 a DL channel measurement configuration information. As an example, the configuration may include one or more of:
(1) DL reference signal resource (RX sub-band) and TCI state, e.g., CSI-RS resource, SSB resource, CORESET resource (PDCCH DMRS) and scheduled PDSCH resource (PDSCH DMRS);
(2) Associated simultaneous UL transmission and TCI state, e.g., SRS, PUCCH, PUSCH, dedicated UL signal and the UL TX frequency resource (TX sub-band);
(3) CSI measurement, e.g., CQI, L1-SINR, L1-RSRP, RSRQ, RSSI, interference measurement; and/or
(4) Hypothesis information of hypothetical/candidate simultaneous UL transmission. Hypothesis information may related to assumptions about particular transmission parameters, e.g., transmit power level, UL transmission TCI state, TX and/or RX polarization, DL and UL frequency resource allocation (e.g., DL and UL frequency resource separation, number of allocated RBs).

Next, the WTRU may receive 410 an indication to perform the DL channel measurement, e.g., Periodical via RRC signaling/Aperiodic via MAC CE and/or DCI triggering. The WTRU performs 415 an actual DL channel measurement of the indicated DL RS with the associated simultaneous UL transmission according to the configuration. Examples options include using a (pre)configured delay between the start of the measurement and transmission (e.g., to allow SIC tuning and settling) and/or the RX beam and TX beam used for the measurement and transmission according to the TCI state configured for the DL reference signal and UL transmission.

The WTRU may determine 420 an actual CSI, e.g., CQI and/or SINR based on the performed DL channel measurement and determines 425 a SIC ratio offset for each configured hypothetical/candidate UL transmission relative to the configuration of the actual simultaneous UL transmission, e.g., based on the calibrated SIC ratio data specific to the UL TCI state, TX antenna panel polarization, UL frequency resource allocation, transmission power, etc.

In a first option, the WTRU transmits 430 a report including the actual CSI and determined SIC ratio offsets corresponding to the configured hypothetical UL transmissions. In a second option, the WTRU determines 430 hypothetical CSI, e.g., CQI and/or SINR for each configured hypothetical UL transmission based on the actual CSI and the corresponding SIC ratio offset (e.g., addition/subtraction as previously discussed). Lastly, the WTRU may transmit 435 a measurement report, e.g., including both actual and hypothetical CSI information corresponding to the configured hypothetical UL transmissions. In one example, the WTRU determines to include a subset of hypothetical CSI in the reports, e.g., those higher than the measured CQI/SINR by a threshold. As with any method disclosed herein, steps of method 400 may be omitted, performed in different order and/or combined with other steps or information in this disclosure.

Method 400 enables a WTRU to measure a reception quality with a simultaneous transmission and provide this information to gNB for the purpose of scheduling simultaneous downlink reception and uplink transmission for improving the DL and/or UL capacity. The hypothesis measurement reduces the need for WTRU to make additional actual measurement for different hypothetic simultaneous UL transmission with different parameters and thereby save WTRU processing and power consumption.

A specific method for a WTRU may include receiving downlink (DL) channel measurement configuration information including: (i) a RX configuration of a DL reference signal (RS) in a receive (RX) sub-band and a first TX configuration of an associated actual simultaneous uplink (UL) RS in a transmit (TX) sub-band; and (ii) a second TX configuration of a candidate simultaneous uplink (UL) RS in the transmit (TX) sub-band. The WTRU measures the received DL RS associated with the actual simultaneous UL RS transmission according to the RX configuration and the first TX configuration, respectively. The WTRU may determine an actual CSI based on the measured DL RS for the first RX and TX configuration and determines a self-interference cancellation (SIC) value based on for the second TX configuration for the candidates UL RS relative to the first TX configuration. The WTRU may report, to a gNB, the determined actual CSI, the first TX configuration and/or the determined SIC value corresponding to the second TX configuration.

In one example, the SIC value is a SIC ratio or a SIC offset corresponding to the difference of one or more parameter(s) between the first TX configuration and the second TX configuration. In another example aspect, reporting the determined SIC value includes reporting a hypothetical CSI for the candidate simultaneous UL RS for future simultaneous UL transmission using the second TX configuration. In one example, the hypothetical CSI is based on the actual CSI and the determined SIC value. In another example, only the hypothetical CSI which exceed a configured CSI threshold are reported.

In various examples, the DL RS may be one of a control resource set (CORESET), a synchronization signal block (SSB), a physical downlink control channel (PDCCH) demodulation reference signal (DMRS) or a scheduled physical downlink shared channel (PDSCH) DMRS. The associated simultaneous UL RS may be one of a sounding reference signal (SRS), a physical uplink control channel (PUCCH), a physical uplink shared channel (PUSCH) or a dedicated UL RS. The second TX configuration includes an assumption of one or more transmission parameters for a candidate simultaneous UL transmission including a transmit power level, an UL transmission TCI state, a TX and RX polarization, a TX and RX spatial filter and/or a DL and UL frequency resource allocation. The SIC value may be a SIC ratio offset for a candidate UL RS for future simultaneous UL transmission based on calibrated SIC ratio data of the WTRU specific to the one or more transmission parameters.

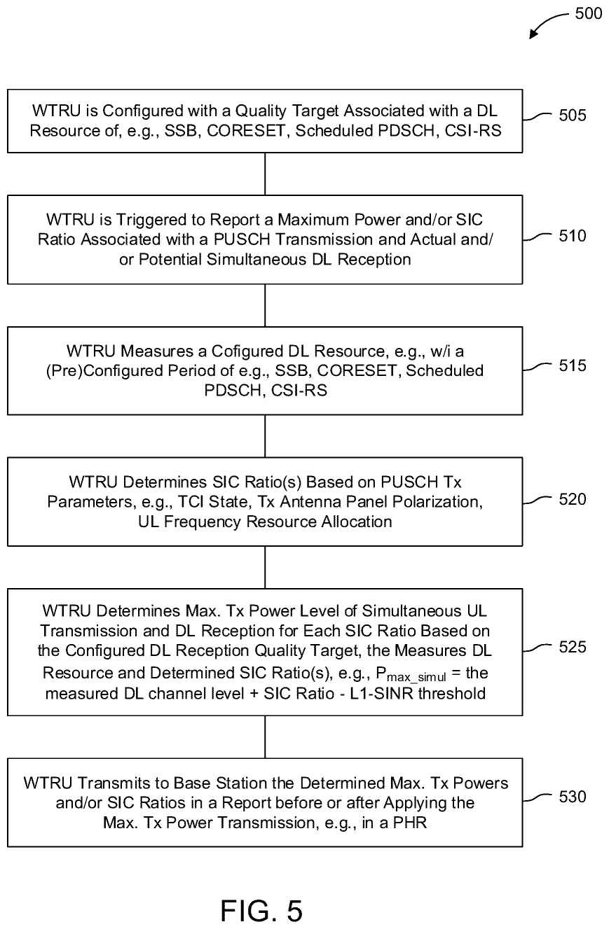

Referring to FIG. 5, a method 500 for WTRU determination and reporting of maximum power of a UL transmission based on an indicated quality target of an associated simultaneous DL reception and a corresponding DL channel measurement is shown according to an example embodiment.

Method 500 may begin with a WTRU receiving 505 configuration information with a quality target associated with a DL resource of e.g., SSB, CORESET, scheduled PDSCH, CSI-RS. As an example, a quality target may relate to a L1-SINR threshold, RX desensitization or other factor described herein. The WTRU is triggered 510 to report a maximum power and/or SIC ratio associated with a PUSCH transmission and actual and/or potential simultaneous DL reception. The WTRU may measure 515 a configured DL resource, e.g., SSB, CORESET, Scheduled PUSCH, CSI-RS, potentially within a (pre)configured period of time.

The WTRU may determine 520 one or more SIC ratio(s) based on the PUSCH transmission parameters, for example, a TCI state, TX antenna panel polarization and/or UL frequency resource allocation. The WTRU determines 525 a maximum transmit power level of a simultaneous UL transmission and DL reception for each SIC ratio based on the configured DL reception quality target, the performed DL measurement and the determined SIC ratio(s), e.g., P_{max_simul}=the measured DL channel level+SIC ratio-L1−SINR threshold. Lastly, the WTRU may transmit to the gNB, the determined maximum transmit powers and/or SIC ratios in a report, either before or after applying the maximum power transmit. (e.g., in a PHR). As with other methods disclosed herein, steps of method 500 may be omitted, modified, performed in different order and/or combined with other steps or information described in this disclosure.

Method 500 enables a WTRU to provide maximum transmit power information associated with a simultaneous UL transmission and DL reception to gNB so that the gNB can select proper transmission parameters to ensure the quality of the simultaneous DL reception, i.e. the UL transmit power will not cause a degradation of the associated DL reception. In addition, the information can help gNB to prioritize between the UL and DL and send a DCI with indication to drop the simultaneous DL reception.

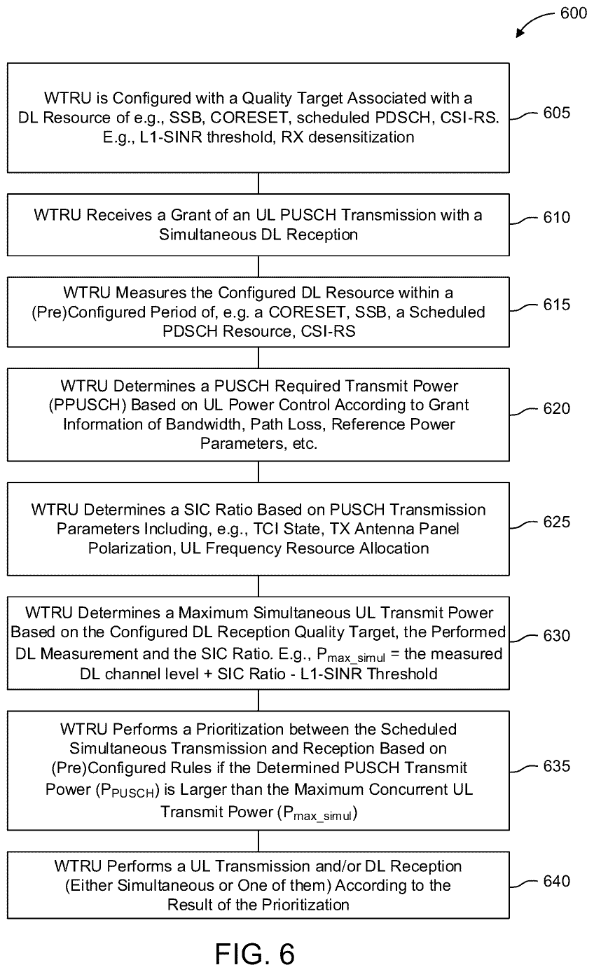

Referring to FIG. 6, a method 600 is shown for WTRU determination of WTRU-side SBFD maximum UL transmit power based an indicated quality target of a simultaneous DL reception quality target and a corresponding DL channel measurement and further prioritization between the UL transmission and DL reception according to an example embodiment.

Method 600 may begin with a WTRU receiving 605 configuration information including a quality target associated with a DL resource, e.g., SSB, CORESET, scheduled PDSCH, CSI-RS. As an example, a quality target may relate to a L1-SINR threshold, RX desensitization or other factor described herein. The WTRU receives 610 a grant of an UL PUSCH transmission with a simultaneous DL reception and measures 615 the configured DL resource, e.g., a received CORESET, SSB, a scheduled PDSCH resource or CSI-RS. In an example, the DL resource may be measured within a (pre)configured period of time. The WTRU determines 620 a PUSCH required transmit power (PPUSCH) based on UL power control according to the grant information of bandwidth, path loss, reference power parameters, etc. The WTRU determines 625 a SIC ratio based on the PUSCH transmission parameters, e.g., a TCI state, TX antenna panel polarization, UL frequency resource allocation.

The WTRU may determine 630 a maximum simultaneous UL transmit power based on the configured DL reception quality target, the performed DL measurement and the SIC ratio, e.g., P_{max_simul}=the measured DL channel level+SIC ratio−L 1-SINR threshold. In some embodiments, the WTRU may perform 635 a prioritization between the scheduled simultaneous transmission and reception based on (pre)configured rules if the determined PUSCH transmit power (PPUSCH) is larger than the maximum concurrent UL transmit power (P_{max_simul}). As previously described, the rules for prioritization may be based on the priority for PUSCH and the type and/or priority of the DL signals (PDCCH/SSB/PDSCH/CSI-RS). In one example, the UL transmission may be sent with the calculated required transmit power (e.g., “best effort”). Lastly, the WTRU performs 640 a UL transmission and/or DL reception (either simultaneous or one of them) according to the result of the prioritization at step 635. As with other methods disclosed herein, steps of method 600 may be omitted, modified, performed in different order and/or combined with other steps or information described in this disclosure.

Method 600 enables a WTRU to compute a maximum transmit power of a given UL grant with a simultaneous DL reception to ensure a DL quality target and subsequently determine whether to perform a prioritization based on the comparison between the computed maximum transmit power and transmit power computed based on a non-simultaneous, e.g., legacy, PUSCH power control.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit receive unit (WTRU), the method comprising:
receiving downlink (DL) channel measurement configuration information including: (i) a RX configuration of a DL reference signal (RS) in a receive (RX) sub-band and a first TX configuration of an associated simultaneous uplink (UL) RS in a transmit (TX) sub-band; and (ii) a second TX configuration of a candidate simultaneous UL RS in the TX sub-band;
measuring the DL RS with the associated simultaneous UL RS transmission according to the RX configuration and the first TX configuration, respectively;
determining an actual CSI based on the measured DL RS for the first TX configuration;
determining a self-interference cancellation (SIC) value based on for the second TX configuration relative to the first TX configuration; and
reporting, to a gNB, the determined actual CSI, the first TX configuration and the determined SIC value corresponding to the second TX configuration.

2. The method of claim 1, wherein the SIC value comprises a SIC ratio or a SIC offset corresponding to a difference of one or more parameter(s) between the first TX configuration and the second TX configuration.

3. The method of claim 1, wherein reporting the determined SIC value comprises reporting a hypothetical CSI for the candidate simultaneous UL RS for future simultaneous UL transmission using the second TX configuration.

4. The method of claim 3, wherein the hypothetical CSI is based on the actual CSI and the determined SIC value.

5. The method of claim 4, wherein only the hypothetical CSI which exceed a configured CSI threshold are reported.

6. The method of claim 1, wherein the DL RS comprises one of a control resource set (CORESET), a synchronization signal block (SSB), a physical downlink control channel (PDCCH) demodulation reference signal (DMRS) or a scheduled physical downlink shared channel (PDSCH) DMRS.

7. The method of claim 1, wherein the associated simultaneous UL RS comprises one of a sounding reference signal (SRS), a physical uplink control channel (PUCCH), a physical uplink shared channel (PUSCH) or a dedicated UL RS.

8. The method of claim 1, wherein the second TX configuration comprises an assumption of one or more transmission parameters including at least one of a transmit power level, an UL transmission TCI state, a TX and RX polarization, a TX and RX spatial filter or a DL and UL frequency resource allocation.

9. The method of claim 8, wherein the SIC value comprises a SIC ratio offset for a candidate UL RS for future simultaneous UL transmission based on calibrated SIC ratio data of the WTRU specific to the one or more transmission parameters.

10. A wireless transmit receive unit (WTRU):
a transceiver; and
a processor communicatively coupled to the transceiver, wherein the transceiver and the processor are configured to:
receive downlink (DL) channel measurement configuration information including: (i) a RX configuration of a DL reference signal (RS) in a receive (RX) sub-band and a first TX configuration of an associated simultaneous uplink (UL) RS in a transmit (TX) sub-band; and (ii) a second TX configuration of a candidate simultaneous UL RS in the TX sub-band;
measure the DL RS with the associated simultaneous UL RS transmission according to the RX configuration and the first TX configuration, respectively;
determine an actual CSI based on the measured DL RS for the first TX configuration;
determine a self-interference cancellation (SIC) value based on for the second TX configuration relative to the first TX configuration; and
report, to a gNB, the determined actual CSI, the first TX configuration and the determined SIC value corresponding to the second TX configuration.

11. The WTRU of claim 10, wherein the SIC value comprises a SIC ratio or a SIC offset corresponding to a difference of one or more parameter(s) between the first TX configuration and the second TX configuration.

12. The WTRU of claim 10, wherein reporting the determined SIC value comprises reporting a hypothetical CSI for the candidate simultaneous UL RS for future simultaneous UL transmission using the second TX configuration.

13. The WTRU of claim 12, wherein the hypothetical CSI is based on the actual CSI and the determined SIC value.

14. The WTRU of claim 13, wherein only the hypothetical CSI which exceed a configured CSI threshold are reported.

15. The WTRU of claim 10, wherein the DL RS comprises one of a control resource set (CORESET), a synchronization signal block (SSB), a physical downlink control channel (PDCCH) demodulation reference signal (DMRS) or a scheduled physical downlink shared channel (PDSCH) DMRS.

16. The WTRU of claim 10, wherein the associated simultaneous UL RS comprises one of a sounding reference signal (SRS), a physical uplink control channel (PUCCH), a physical uplink shared channel (PUSCH) or a dedicated UL RS.

17. The WTRU of claim 10, wherein the second TX configuration comprises an assumption of one or more transmission parameters including at least one of a transmit power level, an UL transmission TCI state, a TX and RX polarization, a TX and RX spatial filter or a DL and UL frequency resource allocation.

18. The WTRU of claim 17, wherein the SIC value comprises a SIC ratio offset for a candidate UL RS for future simultaneous UL transmission based on calibrated SIC ratio data of the WTRU specific to the one or more transmission parameters.
